(19) United States
(12) Patent Application Publication
(10) Pub. No.: US 2021/0224820 A1
(43) Pub. Date: Jul. 22, 2021

(54) MANAGEMENT OF VEHICLES ON PUBLIC INFRASTRUCTURE

(71) Applicant: DIGITAL UNITY, INC., Santa Monica, CA (US)

(72) Inventor: Scott FRANKEL, Santa Monica, CA (US)

(21) Appl. No.: 17/204,729

(22) Filed: Mar. 17, 2021

Related U.S. Application Data
(63) Continuation of application No. PCT/US2019/051374, filed on Sep. 17, 2019.
Application No. PCT/US2019/051374 is a continuation of application No. PCT/US2019/051377, filed on Sep. 17, 2019.
(60) Provisional application No. 62/841,141, filed on Apr. 30, 2019.
(60) Provisional application No. 62/748,246, filed on Oct. 19, 2018.
(60) Provisional application No. 62/732,881, filed on Sep. 18, 2018.
(60) Provisional application No. 62/841,141, filed on Apr. 30, 2019.
(60) Provisional application No. 62/748,246, filed on Oct. 19, 2018.
(60) Provisional application No. 62/732,881, filed on Sep. 18, 2018.

(51) Int. Cl. G06Q 30/00; G08G 1/00; G07C 5/08; H04W 4/02; H04W 4/029; H04W 4/021; G06Q 50/26; G06Q 10/06

(52) U.S. Cl. CPC G06Q 30/018; G08G 1/20; G07C 5/0808; G07C 5/0825; G06Q 10/06315; H04W 4/023; H04W 4/029; H04W 4/021; G06Q 50/26; G07C 5/0841

(57) ABSTRACT

A centralized asset management system for enforcement of asset parameters on assets that utilize public infrastructure. Assets may include shareable dockless mobility vehicles such as dockless scooters, bicycles, or the like. Assets may also include autonomous vehicles such as delivery drones or autonomous ride share vehicles. The system receives asset data such as the geolocation of an asset an compares the asset data to asset parameters. For example, asset parameters may include defined areas regarding the operation of assets such as areas for asset parking or the like. The system may allow a municipality user to access the system to define the asset parameters. The system may include interfaces with asset operators and the municipality to share relevant data regarding the assets or their operation.

### CROSS-REFERENCE TO RELATED APPLICATIONS

The present application claims priority under 35 U.S.C. § 120 as a continuation of PCT Application No. PCT/US2019/051374 entitled “MANAGEMENT OF VEHICLES ON PUBLIC INFRASTRUCTURE” filed on 17 Sep. 2019, which claims benefit of priority to U.S. Provisional Patent Application No. 62/732,881 entitled “SYSTEMS AND METHODS FOR MANAGEMENT OF PORTABLE VEHICLES AND STRUCTURES WITHIN A MUNICIPALITY THAT ACCESS PUBLIC INFRASTRUCTURE” filed on 18 Sep. 2018; U.S. Provisional Patent Application No. 62/748,246 entitled “SYSTEMS AND METHODS FOR MANAGEMENT OF PORTABLE VEHICLES NAD STRUCTURES WITHIN A MUNICIPALITY THAT ACCESS PUBLIC INFRASTRUCTURE” filed on 19 Oct. 2018; and U.S. Provisional Patent Application No. 62/841,141 entitled “SMART CITY PUBLIC-PRIVATE TRANSPORTATION INFRASTRUCTURE VIRTUAL SPACE MANAGEMENT SYSTEM” filed on 30 Apr. 2019, each of which is specifically incorporated by reference herein for all that it discloses or teaches.

The present application claims priority under 35 U.S.C. § 120 as a continuation of PCT Application No. PCT/US2019/051377 entitled “MANAGEMENT OF VEHICLES ON PUBLIC INFRASTRUCTURE” filed on 17 Sep. 2019, which claims benefit of priority to U.S. Provisional Patent Application No. 62/732,881 entitled “SYSTEMS AND METHODS FOR MANAGEMENT OF PORTABLE VEHICLES AND STRUCTURES WITHIN A MUNICIPALITY THAT ACCESS PUBLIC INFRASTRUCTURE” filed on 18 Sep. 2018; U.S. Provisional Patent Application No. 62/748,246 entitled “SYSTEMS AND METHODS FOR MANAGEMENT OF PORTABLE VEHICLES NAD STRUCTURES WITHIN A MUNICIPALITY THAT ACCESS PUBLIC INFRASTRUCTURE” filed on 19 Oct. 2018; and U.S. Provisional Patent Application No. 62/841,141 entitled “SMART CITY PUBLIC-PRIVATE TRANSPORTATION INFRASTRUCTURE VIRTUAL SPACE MANAGEMENT SYSTEM” filed on 30 Apr. 2019, each of which is specifically incorporated by reference herein for all that it discloses or teaches.

### BACKGROUND

Technology companies are increasingly deploying physical assets that utilize public infrastructure for a variety of purposes that may include, among others, mobility for individuals and/or delivery of physical items. For example, dockless mobility providers (DMPs) are offering dockless vehicles such as bicycles, scooters, pods, etc., collectively dockless mobility vehicles (DMV″), to users for last mile transportation alternatives. DMP assets can be located by users via GPS enabled technology within a mobile application published and operated by each respective DMP. Once a user locates an asset, the user can identify the unique asset through the DMP application (e.g., by scanning a QR code, using a physical fob or keycard, or entering a unique asset ID associated with the asset) to activate the asset for use by the user. The asset can be used by the user having an active account with the respective asset operator. Once the user completes use of the asset, the user can leave the asset and relinquish use of the asset using the asset operator mobile application. The user is then billed for the use of the asset by the asset operator using information obtained during the time the asset was used by the user (e.g., by time, distance, or other parameter). For example, the user may have a credit card associated with the user's account that is billed for use of the asset.

As another example of an asset that utilizes public infrastructure, autonomous delivery devices (ADDs) including drones, pods, autonomous vehicles, and/or robots have been considered that would use public infrastructure and/or airspace to make deliveries and/or provide mobility to individuals. Use of such ADDs contemplate that each asset would be managed by a respective third party company and deployed when a physical item is requested by a consumer for delivery or a user requests a ride from an origin to a destination. Examples of potential contexts in which ADDs could be used include delivery of a package or a fully autonomous ride share vehicle. Once a user requests use of an ADD, the user enters a requested job, and the third party tech company deploys the relevant asset to accomplish the job.

In either of the foregoing examples, each asset includes a location determination module (e.g., an on-board GPS module) to track the location of the asset and report the assets location back to the asset operator via a data network or the like. This data is managed and collected for each asset by the respective asset. However, initial deployments of assets illustrate the need for regulation and/or management of assets. Specifically, upon initial deployment, assets such as DMVs and ADDs have presented unintended challenges as users begin to employ assets at will without knowledge or regard to the global use cases of the public infrastructure defined by municipal ordinance, operational agreements between a municipality and an asset operator, or the like. For example, parked assets often crowd public thoroughfares or collect at busy locations within an area. Moreover, use of assets in municipality designated prohibited areas such as pedestrian malls or the like pose a threat to public safety. As more of these GPS-enabled assets utilize public infrastructure, municipalities increasingly desire to ensure that industry-specific rules and regulations are adhered by each asset and asset operator, through a scalable, independent monitoring of compliance around such to promote fair use of public infrastructure and help provide improved public safety.

### SUMMARY

The present disclosure relates to an asset management system for enforcement of one or more asset parameters for assets of a plurality of asset providers that use public infrastructure and related methods. The asset management system receive asset data regarding the assets of a plurality of asset operators and compares the asset data to one or more asset parameter using a hardware processor of the asset management system. The asset management system determines that an asset is in non-compliance with the one or more asset parameters and communicates a message from the asset management system in response to determining the non-compliance of the asset.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 depicts an example of a centralized asset management system.

FIG. 2 depicts an example of an asset management server.

FIG. 3 depicts an example of a data structure for asset parameters.

FIG. 4 illustrates an example user setup screen of a centralized asset management system.

FIGS. 5 and 6 illustrate example asset setup screens of a centralized asset management system.

FIG. 7 illustrates an example asset cap screen of a centralized asset management system.

FIG. 8 illustrates an example asset operation hours screen of a centralized asset management system.

FIG. 9 illustrates an example parking management screen of a centralized asset management system.

FIGS. 10-16 illustrate examples of parking area definition screens of a centralized asset management system.

FIG. 17 illustrates an example rider equality management screen of a centralized asset management system.

FIG. 18 illustrates an example clustering management screen of a centralized asset management system.

FIG. 19 illustrates an example data integrity screen of a centralized asset management system.

FIG. 20 illustrates an example ADA setup screen of a centralized asset management system.

FIG. 21 illustrates an example vendor up-time management screen of a centralized asset management system.

FIG. 22-25 illustrates example compliance overview screens of a centralized asset management system.

FIG. 26 illustrates an example safety and maintenance monitoring screen of a centralized asset management system.

FIG. 27 illustrates an example schematic of a processing device suitable for implementing aspects of the disclosed technology.

### DETAILED DESCRIPTIONS

As mentioned above, assets such as DMVs or ADDs typically are deployed into and use public infrastructure such as public sidewalks, public streets, public airspace, or other public thoroughfares. Moreover the unregulated deployment and use of assets create serious concerns regarding the use of public infrastructure. Specifically, when one thinks about physical space in the transportation industry, capacity is the driving factor that allow assets to move and rest in harmony in a given area. When an asset moves from point A to point B using public infrastructure, a goal is to avoid traffic. Similarly, when an asset is no longer in use, a place to rest the asset must be identified so that the asset may park, often doing so on publicly owned land.

While parking locations and availability for traditional transportation modalities such as automobiles or the like have evolved to become common place with visually indicated space allocations (e.g., potentially including municipality managed parking meters), public land for parking, and private land for parking, the paradigm of how to account for parking of the new proliferation of shareable assets provided by asset operators becomes more confusing as such assets are not owned by users parking the assets and are often parked on sidewalks or other public space that are shared by multiple types of users and objects. Furthermore, as such assets do not always need to be locked to a physical object, when a user is finished with their ride, the user can leave the device anywhere they see fit, with the public sidewalk infrastructure as the mainstay for parking. Because the users of the assets do not own the assets and have not been held accountable for the misuse of assets, there may be less incentive for users to comply with ordinances or the like. That is, sidewalks were originally designed to handle the public right of way for pedestrians, bike racks, mailboxes, trash cans, bus/taxi zones, loading zones, etc. without also facilitating parking of potentially large numbers of shared assets. As such, the paradigm of the public sidewalk infrastructure is now challenged with the rapid increase of assets being introduced into cities worldwide, as these privately owned devices often rely on the public sidewalk infrastructure for parking.

With this being the case, rather than relying on municipalities to provide and/or physically mark public infrastructure with approved parking areas for the new assets or installing a network of expensive physical racks, cities may delegate the responsibilities of asset management onto asset operators. Municipalities may potentially designate approved or disapproved areas to park or utilize privately owned assets on the public infrastructure. For example, definitions of approved/disapproved parking locations may be provided in municipal ordinances or be incorporated into operating agreements between a municipality and asset operators authorized to deploy assets in a municipality. For example, asset operators may be allowed to have their devices parked on the public sidewalk infrastructure, as long as they do not block the public right-of-way, bus stops, benches, fire hydrants, or in crosswalks, etc. Asset operators may be asked to educate their riders to park in approved areas or other logically available places as to not interfere with the others that access the sidewalks.

For instance, in the design of sidewalks, municipalities often incorporate a number of logical “zones” or areas into the sidewalk to facilitate varying objectives served by the sidewalk. Starting from the inner most area away from a street and moving toward the street, sidewalks may include a frontage zone, a pedestrian through zone, a furniture zone, and an enhancement zone. The frontage zone functions as an extension of the building or private land and may include entryways, doors, patios, sidewalk cafes, signage, outdoor racks, or the like. Next is the pedestrian through zone that provides a clear pathway to provide a place for pedestrians to pass. Pedestrian through zones are typically 5 to 12 feet wide. The furniture zone includes the space between the pedestrian through zone and the curb that allows for amenities such as street furniture, lighting, benches, utility poles, trees, planters and bicycle parking. Enhancement zones may be provided as curb extensions, parklets, stormwater management features, parking, bike lanes, or other features.

However, while municipalities may designate approved/disapproved areas for parking and/or operation of assets through ordinance or agreement with asset providers, enforcing compliance around where such assets are being used or parked has been problematic for cities. For example, users are not always aware of the rules regarding parking or operation of an asset, which can be different between each jurisdiction. Furthermore, the lack of visually identified parking areas or publicly posted rules regarding asset use may contribute to rider confusion. Further still, asset operators are currently not penalized if their users are parking or using assets improperly.

Further complicating enforcement efforts is the fact that multiple asset operators may operate in a given municipality that do not share data with each other. Accordingly, even if an asset operator offers enforcement of rules on their users through each asset operator's respective application, the asset operator only has information regarding the assets they operate. However, regulations enforced by a municipality may be defined in terms of aggregate assets without reference or regard to individual asset operators. For example, a regulation may preclude parking of a total number of assets in excess of an asset limit for a given geographic. While any given asset operator may be able to monitor the number of their assets within their respective fleet in the given geographic area, asset operators are often not aware of what other assets (e.g., assets from other asset providers) are present that factor into determination of whether the limit on the total number of assets is exceeded in the given area. That is, in addition to monitoring appropriate parking locations, ensuring the availability of space to accommodate assets becomes an additional problem as there is a finite amount of public sidewalk infrastructure that needs to be shared across multiple, fragmented asset operators, and each asset operator may be unaware of the activities of other asset operators operating in the same municipality.

Thus, there is still a need for systems and methods to handle the complex challenges of a multitude of independent asset operators that access a fixed amount of approved public sidewalk infrastructure. The present disclosure describes the aggregation of information regarding all the supply-side assets, across multiple asset operators, and routing these assets to both approved and available space to park on the public sidewalk infrastructure. Specifically, municipalities increasingly desire more transparency regarding asset usage and wish to gain access to location-specific data of assets to not only digitally monitor regulations regarding assets, but also automate the compliance monitoring relating to asset usage defined by ordinance or agreement with asset providers. As contemplated herein, compliance monitoring by a centralized asset management system may include determining whether an asset is in compliance or non-compliance with asset parameters regarding the usage of assets on public infrastructure. The centralized asset management system may, in turn, provide messaging to asset operators and/or asset users regarding the compliance or non-compliance of an asset. The messaging may include punitive financial disincentives (e.g., fines) or positive rewards for compliance. Asset data may be collected and analyzed in real-time or near real time to allow for messaging to be provided to asset operator and/or users related to compliance or non-compliance of an asset in real time or near-real time.

In turn and as described herein in more detail below, a centralized asset management system can be provided to facilitate the ability to monitor, manage and implement asset parameters regarding any third party technology company or other asset operator that has one or more assets deployed within a given geographic area such as a given municipality or the like. Such assets managed by the centralized asset management system may include, for example, portable vehicles and/or structures that access or utilize public infrastructure (e.g., streets, sidewalks and airspace). Preferably, assets to be monitored include some location aware tracking such as GPS technology or the like. Exemplary assets include, for example, rented or borrowed devices such as dockless bicycles, e-scooters, e-bikes, pods, drones, autonomous vehicles, food carts and any other mobile equipment that may be permitted to utilize certain public infrastructure and whose location can be monitored. Such assets are typically operated and managed by a third-party company (i.e., an asset operator) that is distinct from the municipality, although asset operators may or may not partner with the municipality in various ways. In any regard, the location of such assets can preferably be monitored, and the location information transmitted to the centralized asset management system in real time or near real time. If assets become non-complaint with predefined asset parameters that were agreed to by the asset operator and/or further outlined by local laws and ordinances, messaging may be provided to the asset operator and/or asset user in real time or near real time. Additionally or alternatively, it is also contemplated that a positive reward may be communicated to an asset operator or asset user for an asset that is operated in compliance with the predefined asset parameters.

Preferred centralized asset management systems described herein may be configured to generate and/or receive data, preferably real-time or near real-time data, from one or more asset operators (e.g., DMPs) that operate assets in a defined geographic area. In one example, asset data may be communicated to the centralized asset management system by the asset operators. Such asset data can be provided to the system via an application programming interface (API) or other data feed between an asset operator and the centralized asset management system. The centralized asset management system may also provide access to a municipality entity or municipality users to view, define, and/or apply asset parameters to each asset operator and their respective assets. Such asset parameters could be specific to an individual asset operators or may be globally-applied to all asset operators monitored using the centralized asset management system in a given geographic area.

One particular advantage of a centralized asset management system as contemplated herein is the ability to aggregate asset data across a plurality of asset operators. In turn, asset parameters may be defined and/or applied to asset data without regard to a specific asset operator of an asset. For example, each asset operator can manage a fleet of up to 10,000 or more assets per city, with some cities having as few as two asset operators, with others having as many as thirteen or more independent asset operators. As may be appreciated, all asset providers in a city may access and park on public infrastructure such as sidewalks or the like. While each asset operator has full transparency regarding each GPS-enabled asset under their control, they do not have the visibility on the assets of other asset operators.

One such problem that may arise when asset operators do not have insight into assets of other asset operators is clustering. Clustering may refer to the presence of too many physical assets within a defined geographic area. The limit on assets within a defined geographic area may be applied to individual asset operators, individual asset types, or may be applied across all operators and/or all asset types within a municipality. Accordingly, clustering is something cities and asset operators are currently able to address individually, but only in limited areas. Each asset operator currently monitors their own fleet of assets and can educate their respective users on where an asset can be parked and/or operated appropriately based on city ordinances, but current approaches do not allow monitoring of asset parameters across a plurality of asset operators.

For example, a given municipality may allow three asset operators to have fleets of 500 assets each, or 1,500 total assets in the municipality. The city may also have a clustering rule around the number of assets that can park within a single city block, which limits the total number of assets in any given city block to four regardless of the asset operator. While each individual asset operator can monitor how many of their assets may be present on any given city block and limit their assets to below the limit, each asset operator is unaware of how many assets of other asset operators are present on the same block, yielding as many as four assets per asset operator, or twelve total assets, three times the limit imposed by the city.

As will be described in greater detail below, the centralized asset management system is configured to allow designation of areas with asset parameters that may include rules regarding asset parking and operation. The definition of areas and/or rules may be provided using the centralized asset management system. In relation to approaches to defining areas using the centralized asset management system, a number of approaches may be used. For example, an area may be defined by a physical address (e.g., including street address, zip code, or the like), by a shape (e.g., a polygon or the like) on a map, by providing Geographical Information System (GIS) data. In other approaches may include using Natural Language Processing to parse and extract area definitions from textual data such as an ordinance or the like, computer vision for recognition of specific areas, machine learning, artificial intelligence, or the like to automatically apply parameters on a map within the specific municipality (i.e. the “furniture zone” of the sidewalk). Any or all of the foregoing may be used universally in the centralized asset management system to define an area in the system.

In turn, in the centralized asset management system, designated areas may be associated with asset parameters. Asset parameters may include definitions of compliant and/or non-compliant asset usage in a given area. In this regard, asset parameters may define allowed or disallowed usage of an asset. A designated area may be associated with one or more asset parameters to define compliant and/or non-compliant usage of an asset in a given area. Different areas may have different asset parameters applied. Moreover, universally applied asset parameters may be provided for the entirety of a geographic area managed by the centralized asset management system.

Designated areas by the centralized asset management system may include, but are not limited to, physically viewable areas such as painted or clearly marked zones (e.g., physically marked portions of streets or sidewalks). Additionally or alternatively, the centralized asset management system may provide data regarding designated areas to a user in a number of manners that do not include physical marking of such areas. For instance, an area may become viewable by a user via augmented reality on a software application. For instance, the centralized asset management system may include an augmented reality interface accessible by a user or may provide data to another platform for generation of an augmented reality overlay. In this latter regard, data may be provided by the centralized asset management system to one or more asset operators to facilitate generating of an augmented reality interface that may be accessible via mobile devices of the asset operators. Accordingly, when a user chooses to finalize use of an asset using asset operator software, the asset operator software may receive information (e.g., in real time or near real time). Such information may include an indication of actions to be taken to be compliant with asset parameters such as, for example, available compliant parking locations near to where the asset is currently located. Through the centralized asset management system or based on information received from the centralized asset management system, an asset user may be guided to an appropriate parking area. In the context of an augmented reality presentation of such data, the directions or other indications of appropriate parking areas may be shown to the user in augmented reality by leveraging equipment of the user's device such as a camera, compass, GPS module, accelerometer, or the like. The augmented reality display may be generated using worn hardware deceives such as smart glasses, an augmented reality headset, or the like. The augmented reality display information may be provided by the centralized asset management system or may be generated by another entity (e.g., an asset operator via a software application or the like) based on data received from the centralized asset management system.

While an augmented reality display is contemplated above, other methodologies may be utilized to present data to a user in real time or near real time to guide compliant usage of an asset. For example, directions could be provided to a user regarding a parking area on a traditional display screen of the user device and/or through audio guidance. It is further contemplated that information from the centralized asset management system may also be provided to a third party hardware source including, but not limited to, a head-up-display mounted on an asset, a hardware device to deliver a holographic parking area/zone that may be physically present on municipal land using a camera, projector, or image generator. Furthermore, the nature of the information provided and/or the manner in which information from the centralized asset management system is presented may be based on the hardware present for the user or asset. For example, if holographic generators or optically worn hardware is present on the rider, contextually relevant augmented realty direction data may be provided for identification of the parking area. If such hardware is not available, other methods such as presentation of a map display on a user device may be used. Further still, any such guidance information provided to the user may be provided prior to a user beginning a trip (e.g., the user may indicate a destination and guidance data including or based on information from the asset management server 200 may be used to provide guidance on operation and/or parking to the user). Alternatively, a user may be presented guidance data including or based on information from the asset management server 200 upon a user's request to end a trip.

Accordingly, after asset parameters regarding assets and/or asset operation are established or entered into the centralized asset management system, information may be disseminated from the centralized asset management system to each asset operator (e.g., information can be provided through an externally accessible API of the centralized asset management system). The information may be available in real time or near real time and further disseminated to each user to alert the user to information including where to park, that the user is in non-compliance with an asset parameter, or the like. Instructions given to the user can include, for example, a physical street address, a general intersection, a visual indicator such as via augmented reality (e.g., green zones in the augmented reality display are approved areas and red areas are unapproved areas), a landmark or business, a set of directions (e.g., in the furniture zone of the sidewalk).

Furthermore, the information may include messaging regarding compliance and/or non-compliance with the asset parameters generally. Such messaging may include various levels of severity. For example, a message may include an informational notice or warning of non-compliance. The informational notice or warning may further include a grace period in which the non-compliance must be remedied before receiving a citation or other financial penalty or fine. In still other contexts, a message may include a citation or fine immediately upon determining non-compliance of an asset. Further still, messages may be provided to asset operators and/or asset that indicate or confirm an asset is in compliance with all asset parameters. Such a positive feedback message may be accompanied by a positive reward such as a discount for future asset uses or other potential benefits like rewards points, discounts at third party retailers, or the like. Any messaging may be provided to an asset operator for forwarding to an asset user (e.g., through the asset operator software application) or may be provided directly to an asset user.

For example, a message may be provided to an asset operator, which may in turn issue a corresponding message to users of the assets that resulted in compliance or non-compliance. As further example, if a user does not comply with an asset parameter and parks or utilizes an asset where not indicated or otherwise is in non-compliance with one or more asset parameters, the user may be sent a warning via a push notification, text message, email, or via the asset operator software. The warning may inform the user that the asset they are using is in non-compliance. Continued non-compliance may result in fines being issues to the asset operator or the asset user. The centralized asset management system can be configured to automatically send such notice and can also be configured to assess a reward, fine, or other penalty to the user or asset operator. It is also contemplated that a user could optionally not be able to surrender back the asset until the asset is in compliance (e.g., properly parked). It is also further contemplated, that prior to a fine being levied, the system can offer a grace period to correct the non-compliance. In an example, a rider may improperly park an asset in an unapproved area. There could be an alert sent to the asset operator and/or asset user that the parked asset is non-compliant. The municipality may have a defined grace period in which the non-compliance may be remedied prior to receiving a citation or the like. Each asset parameter may or may not include such a grace period, and asset parameters that include grace periods may have different such grace period durations applied to respective ones of the asset parameters. Furthering the example above, a notification to correct a parking infraction may be provided (e.g., with instructions for doing so) within a specified period of time (e.g., 60 minutes) prior to a fine being issued. This system may monitor the duration that the asset is improperly parked. If the asset is moved to an approved location, no negative action may be issued, and the asset operator and/or asset user may be informed that the asset is in compliance. Alternatively, if the asset is not properly moved within the designated grace period, the asset operator and/or asset use would be alerted and a fine may be levied. It is further contemplated that if a particular approved parking area is at capacity or clustering rules may be violated upon the parking of a new asset in the particular parking area, the rider may be offered a positive incentive if the rider were to park the asset in another area deemed acceptable.

In the context in which penalties or fines are imposed, the fine amount for non-compliance may be determined by the municipality or other user. Fine amounts may vary depending on asset parameter. For example, fine amounts may be at least in part based on where the user is operating the asset and/or the nature of the non-compliance of the asset. As described above, fines may be imposed on the asset operator and/or directly to the asset user. In relation to assessing fines to the asset operator, the centralized asset management system may generate a master super bill related to all fines for a given asset operator in a given timeframe. The master super bill may be provided from the centralized asset management system to a municipality for issuance of fines to the asset operator based on the master super bill or the master super bill may be provided directly from the asset management system to the asset operator. In turn, the asset operator may issue fines or penalties to users using the assets at the time of a citation based on correlation between information regarding the fine and information regarding a user in possession of an asset during the time of the fine. These fines may be dynamic and adjusted in real time by the municipality. Such infractions can be automatically monitored by the system and the fines issued in real-time or not.

It is further contemplated that a municipality may charge asset operators a fee related to usage of assets. Such usage fees may relate to parking of assets, use of assets within a municipality, or other characteristic of the use of an asset. For example, a municipality may issue a parking fee to have assets parked on the public infrastructure, similar to the operation of a traditional parking meter. For example, the fee for utilization of public infrastructure may be mandated by operating agreements or municipal code. Once a ride is completed, there could be an automatic charge billed to each ride as a fee for the use of the asset. This could be billed to the user as part of the use of the asset or could be paid by the asset operator (e.g., the asset operator may be billed in bulk for all such accumulated fees over a given time period). Such bulk billing may include interfaces that may be presented to a municipality that includes any fees due for a given period, status of payment of fees, or other information regarding charges applied to a given asset operator. It is even further contemplated that the fee could be dynamic based on peak parking areas or times similar to how a physical parking meter can “flex” the parking fee based on demand (high or low). The centralized asset management system may allow a municipality to create fee structures for asset use and/or parking with minimum fee, maximum fees, and/or other determinations for how to arrive at a fee based on one or more parameters.

In another specifically contemplated example of the centralized asset management system, an asset parameter may include one or more safety rules regarding operation of an asset in a municipality. For example, with assets gaining popularity, some jurisdictions require the use of a helmet (or other safety equipment) when using an asset such as a scooter or e-bike. However, there is no current scalable way to enforce this. As such, it is contemplated that the centralized asset management system may have one or more asset parameters to allow for the centralized asset management system to enforce such safety rules. For example, it is contemplated that the helmet could have a chip or unique indicia that that is read or capable of sending a signal in connection with activation of the asset. Absent such proof that a helmet is present in the form of such a signal, the ride may not be initiated as enforced by the centralized asset management system. Such a verification transmission between a helmet and asset or user device could occur over any suitable protocol including, for example, physical code, NFC, Bluetooth or other protocol. In the case where a machine-readable indicia is used to identify the presence of a helmet, a QR code, bar-code, or other machine-readable indicia may be used. As such, it is contemplated that the user device or asset could have a camera or scanner to read the machine-readable indicia and thereby activate the device.

Although the above discussion primarily focused on the use of the centralized asset management system with DMVs, it is also contemplated that the system could be used to monitor and manage other assets including street vendors or other vendors operating on public infrastructure. For example, when a street vendor is licensed to operate in a municipality, the vendor could be issued a beacon that is GPS enabled so that the location of the vendor can be determined and monitored by the centralized asset monitoring system. It is further contemplated, that as opposed to a physical beacon, this system could also function via mobile application, accessible by street vendors, as the smartphone could act as the beacon to broadcast the street vendors location. It is contemplated that vendors could interact with the central asset management system via a desktop or mobile application, for example, to register with the city, pay fees or taxes, and activate the sharing of their location when vending. Where mobile phones or other portable computing devices with a GPS chip are utilized, the phone or other device could act as the beacon for location awareness. The vendor can further utilize the application to receive messages (e.g., instructions and notifications) to make sure they are following the asset parameters established by a municipality regarding the operation of the street vendor. This will advantageously permit municipalities to monitor street and other vendors, and better understand how many are operating and where they are located. Because their locations can be monitored by the system, their locations could also be provided to a consumer facing interface such that consumers can locate their favorite vendor via a map or other interface. If the municipal rules were not followed, the street vendor could receive notifications via text message, automated phone call, email, or push notification.

In addition or alternatively to enforcement of asset parameters defined by a public municipality, it is contemplated that the centralized asset management system may allow private parties to access the centralized asset management system to create alternative (and/or supplemental), dynamic parking zones on privately owned land to encourage parking or operation of the assets at or near the private land. For instance, parking on the privately owned land may be encouraged by offering an incentive to the rider, such as a free gift, an entry into a drawing, a discount on a product or service, or other incentive. In this regard, private businesses may offer private asset parking to encourage a transaction (or loyalty) to their establishment. It is further contemplated that the system could have an alternative, centralized reward-based system, and function similarly to how credit card points are accrued and redeemed across a plethora of vendors using Blockchain or other reward-based systems. Information about the additional private parking inventory could be disseminated to asset operators which could be further disseminated to users of the asset operator software, similarly to how the municipality-designated parking data is transferred between the centralized asset management system, the asset operator, and the asset user. In such case, the number of assets that could take advantage of an offer could be limited by the system or other asset parameters applicable to the private land may be established so the business and the surrounding area where the assets park are not overwhelmed. The centralized asset management system may have a private landowner access point or interface that private landowners could use to view the total number of dynamic parking spots available (i.e., virtual inventory), on a daily, weekly, monthly or annual basis. These private entities could then choose to purchase the virtual inventory to dynamically designate parking zones as approved parking areas. This approach to access, purchasing, and pricing can closely mimic how digital advertising inventory is commonly purchased, including by incorporating bidding on available space, determined by the number of assets needing to park, or other mechanisms. The total virtual inventory available for purchase may be determined by three factors (i) the total number of approved assets by the municipality in which the business is physically located, (ii) limit the total number of assets that can park at any given business based on the size of the area for said devices, and alternatively (iii) the equal distribution of available dynamic parking spaces to make sure that spaces are equally available around the municipality, while also factoring in high density pickup and drop-off points. This approach not only helps local businesses partake in the sharing economy of asset-based transportation, but also gives local municipalities the ability to designate the parking responsibilities to local businesses to benefit, allowing seamless increases in asset fleets without creating capacity problems on the public infrastructure (sidewalks).

Accordingly, the centralized asset management system may facilitate access to private landowners via an interface to enable the private landowners to make available private land for use by assets. The private landowners may be provided with a financial benefit such as passive parking revenues collected as a parking fee for parking an asset on the private land or the like. To this end, the centralized asset management system may allow a private landowner to access a portal or interface to designate approved geographic areas on their private land and dynamically become a supplier of available land to handle in the increase in asset supply. In turn, the landowner may be compensated for each use of the private land by an asset, including, but not limited to conversion tracking or ROI based mechanisms. Furthermore, the possibility of a conversion tracking mechanism for newly generated in store sales by these riders may be provided. Even In addition, as more landowners create available parking, the centralized asset management may provide a calculation of how many new assets can be allowable as the amount of new parking supply is available.

In a real world example, a city may allow a total number of 1,000 assets to operate in the city daily. However, if the asset count were to increase to 2,000 assets, the public infrastructure may not be adapted to handle this influx of devices based on city designated rules, asset caps, and/or city planning analyses. In turn, new, nonpublic space to park may be required in order to find an equilibrium. All of this public and private parking inventory could be provided to the centralized asset management system to allow the centralized asset management system to determine if additional assets can be operated in the city upon the addition of private parking spaces to the available inventory, be incorporated into the centralized space management system, and delivered dynamically based on a riders final destination. In turn, such available parking inventory could be adopted into each asset operator's software for riders to find parking. As a rider completes their trip, the asset operator may query the centralized asset management system to serve a data feed to the asset operator to assist their rider by showing all public and private space available, helping them park appropriately and avoid a citation parking or clustering citation.

The centralized asset management system may also be used to manage delivery robots, drones, or other ADDs, which utilize municipality streets and airspace paths, it is contemplated that the centralized asset management system could be used to set up approved geographic areas (e.g., including airspace) for use by the ADDs and/or prohibited areas or other areas where such ADDs are not permitted. Further still, asset parameters may extend to other areas of ADD operation including days/times in which operation is permitted, flight ceilings and/or floors, allowable ADD sizes, allowable cargo capacities (e.g., in size and/or weight), noise restrictions, or other asset parameters governing ADDs. In this manner, municipalities may be able to designate where, when, and/or how such assets can travel, including but not limited to areas or airspace, and when they are allowed to operate. For example, each asset operator may be required to have their assets travel via specific paths or operating zones when on publicly owned land or at rest between trips. If an asset of an asset operator in-route or returning asset is not operating within an approved operating zones, each unique asset can be flagged as non-compliant and a message may be provided to the DMP of the asset, including corrective actions or potentially a fine. These actions can be communicated to ADD systems that may be manned or unmanned readable systems. Furthermore, as in the context of DMVs, the centralized asset management system may impose a fee for use of the ADD which may be collected by a municipality in which the ADDs operate.

In still other aspects, it is contemplated that the system could be used to assist with monitoring equitable asset distribution across asset operators. For example, a municipality may desire that each asset operator offers user of assets at discounted rates in economically challenged areas. To help provide visibility to this important aspect of asset operator operation, the centralized asset management system can be configured to allow a municipality to designate an opportunity zone for one or more areas, and then set equitable distribution rules for that zone. For example, in an economically challenged zone, a certain percentage of assets, per DMP operator, should be distributed to address equal opportunity and access to assets. Additionally or alternatively, when a user commences a ride in a rider equity zone, these rides may be discounted in some manner—by the initiation fee or the per minute fee. It is further contemplated that an incentive could be communicated to riders, as by which, if they chose to park in an economically designated opportunity zone, that they could receive a discount on their ride or a credit toward future rides. Designation of the zones could be established by any means described above in relation to designation of areas in the centralized asset management system. If these rider equity rules are not met, it is contemplated that the centralized asset management system could penalize the asset operator per a previous agreement. This could include reducing the number of approved assts, reducing hours of operation, a fine, and/or revoking the asset operator operating permit in the municipality.

As may be appreciated, the centralized asset management system may receive asset data directly from the asset operators that operate the assets in the area enforced using the centralized asset management system. As such, it may be desirable to confirm the accuracy of asset data being provided by the asset operators to avoid an asset operator from supplying inaccurate data to the centralized asset management system (e.g., in an effort to circumvent the asset parameters established for the enforced area). Accordingly, the centralized asset management system may be operative to perform data integrity on received asset data from asset operators. Specifically, it is contemplated that the system could receive data from one or more remote device (e.g., a network of remote devices such as cameras) that are configured to identify and/or monitor the real-time physical presence of DMP assets in situ (e.g., as physically present on a street, sidewalk, or airspace) to ensure data integrity. It is further contemplated that this system would also identify assets in motion. For example, such remote device could include one or more sensors (e.g., a camera, LIDAR, etc.) disposed on a vehicle (e.g., a land or air vehicle) and moved through municipality areas. Sensors may also be affixed to municipal or private land assets (e.g., buildings, light poles, traffic signals, etc.). In turn, the sensors (e.g., whether on a vehicle in motion or at a fixed location) can record data that is analyzed using machine learning and photo recognition to identify assets, by asset operator, date, time, and geo-location (or array of geolocations for assets in motion). This data physically obtained from the area of enforcement may be called field data as it is actual physical measurement of assets in the field at motion and/or at rest. The centralized asset management system may access the real time data from each asset operator (“reported data”), compare the physical presence of assets in the field against the reported data from each respective asset operator. This can be accomplished due to the fact that most assets are labeled to stand out from other companies and could be accomplished via color, wording, or other distinguishing characteristics including, but not limited to, size or shape. In turn, assets may be identified or classified using machine learning, machine intelligence, or artificial intelligence systems.

Accordingly, field data received from a remote device monitoring the physical presence of assets may be received. The field data may identify an asset of a particular asset operator at a particular geolocation. The field data may be cross-checked against asset data received from the asset operator (i.e., reported data) to determine if an asset matching the asset reflected in the field data is present. If an asset is physically present at a specific geo-location at a given time as determined from a remote device, it will be crosschecked with the relevant asset operator of the asset to determine if there is a matching asset reflected in the reported asset data. If there is a match, the reported data is confirmed as accurate. If there is not a match, a data inaccuracy may be determined. Each data inaccuracy could be logged, in the centralized asset management system, by asset operator, time, location, etc. to be reported into the centralized asset management system for further processing including, potentially, issuance of citations to the asset operator with data inaccuracies.

Furthermore, the centralized asset management system may provide insight to asset operators to understand where their network of crowdsourced charging workforce can re-deploy assets after charging or maintenance of the assets. For instance, assets may include a rechargeable battery or require periodic maintenance. As such, each asset operator may employ a group of individuals to pick up assets when their charge is low or maintenance is due, recharge or service the assets, and then redeploy the assets when complete. The charging or servicing of assets is typically performed overnight, which may coincide with many municipality requirements that assets be taken off the streets and re-deployed the following morning. The centralized asset management system may allow asset operators to factor clustering rules or other asset parameters across all asset operator when deploying their assets.

Another problem cities are struggling to address, in a cost-effective and scalable manner, is a better way to manage the growing number of citizens who are voicing frustrations about assets that are improperly parked throughout cities. While cities may have dedicated reporting modalities, where local residents can report improperly parked devices, the current solutions of cities addressing this technological problem are both costly and inefficient: with the necessity of live telephone operators, additional officers to enforce the problems on streets, and with the accuracy of reporting devices lacking accuracy.

To capitalize on this opportunity, an enforcement client such as a mobile application may be provided in communication with the centralized asset management system that may allow citizens or other users to report non-compliant assets. For example, a user may download the mobile application, identify a non-compliant asset (e.g., by scanning the QR code on each improperly parked device or physically enter the unique asset ID), select from a list of pre-populated information regarding the type of infraction and submit specific device non-compliance to the system. Users may include authorized users (e.g., city enforcement personnel) or the general citizenry. In this regard, data received from different users may be treated differently. For example, data from authorized users may immediately be authenticated for processing in the centralized asset management system. However, data from unauthorized users may be required to be verified or otherwise confirmed prior to processing. In any regard, the data captured from the enforcement client may augment the asset data provided by asset operators and data integrity efforts, allowing cities to leverage technology to assist this growing challenge, with an attributable track record of accurately reported infractions, while minimizing their overhead to support the existing reporting modalities. This solution can be licensed to city officials or directly to citizens to capture device non-compliance with a specified level of GPS accuracy, which is triangulated with the cellular connection (or LTE) or the mobile device.

By allowing citizens to capture non-compliance instances as non-peace officers, the centralized asset management system provides an automated abuse monitoring system that cross references geolocation information and a scanned QR code, via a mobile device's triangulated LTE signal for pinpoint accuracy. Furthermore, the system may utilize a mapping API to cross-check the location of the non-compliance event to asset data to accurately cross-check the supplied asset infraction entry to verify the violation. For instance, if a local citizen scanned a QR code and indicated that a device was blocking a sidewalk but was verified to be present in a parking lot, this would be auto-flagged for an inaccuracy. In addition, the system may determine that any citizen is fraudulently reporting infractions, and flag each abusive user to prevent them from submitting additional infractions and prevent them from re-downloading the app based on the device ID and/or phone number associated with their account.

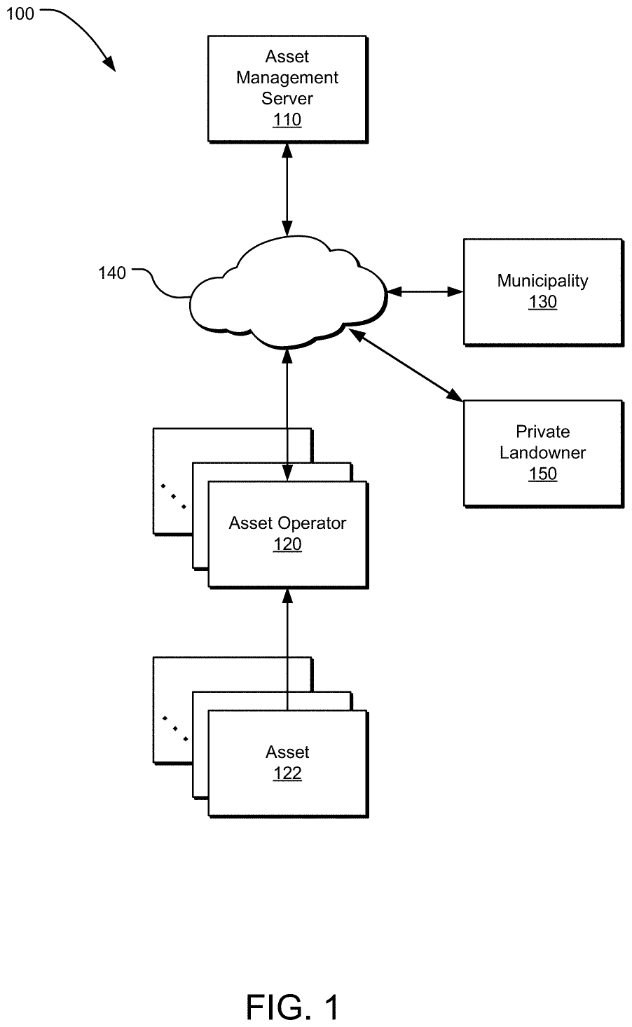

The foregoing aspects and features of the centralized asset management system may be further appreciated with reference to the figures in which FIG. 1 includes an example of an asset management system 100. The system 100 includes an asset management server 110 in operative communication with a network 140. The network 140 may be any appropriate communication network or combination of networks such as, but not limited to, a public switched telephone network (PSTN), a local area network, a cellular data network, wide area network (e.g., the Internet), or other packet-switched data network.

Also in communication with the network 140 are a plurality of asset operators 120. The asset operators 120 may operate assets 122 within a defined geographic area such as a particular municipality or the like. Any number of asset operators 120 may be provided without limitation. Each asset operator 120 may operate a plurality of assets 122 which may be, for example, DMVs, ADDs, or other assets deployed in the defined geographic area that utilize public infrastructure in the geographic area to travel and/or otherwise operate. The asset operators 120 may receive, generate, or otherwise access asset information regarding the assets 122 including, for example, a current location, battery status, orientation, or other information. The current location of an asset 122 may be provided by way of a GNSS, GPS or other technology located onboard each asset 122. In any regard, asset information from the asset operators 120 may be communicated as asset data to the asset management server 110.

A municipality 130 may also be in operative communication with the network 140 in order to access the asset management server 110. The municipality 130 may generally include one or more municipality users that may access the asset management server 110 in a manner discussed in greater detail below. In any regard, the municipality 130 (e.g., one or more of the municipality users) may access the asset management server 110 to observe and/or manage the asset data or asset parameters regarding permissible by the asset operators 120 or forbidden operation of the assets provided. Specifically, the municipality 130 may be operative to view aggregated asset data regarding the assets 122 of the plurality of asset operators 120 centrally using the asset management system 100. In this regard, the municipality 130 may be capable of monitoring all assets 122 from all asset operators 120 that are permitted to operate within the municipality.

One or more private landowners 150 may also communicate with the asset management server 110. For example, the private landowners 150 may access a private landowner interface of the asset management server 110 that allows private landowners 150 to define allowable areas for parking of assets 122 on private land of the private landowners 150. In this regard, private landowners 150 may define specific geographic locations that may be used for parking of assets 122. Moreover, the private landowners 150 may define asset management parameters that define permissible uses and/or other limits in the areas available for private land parking. The private landowners 150 may also define a parking fee or may define a positive incentive for use of the private land of the private landowner 150.

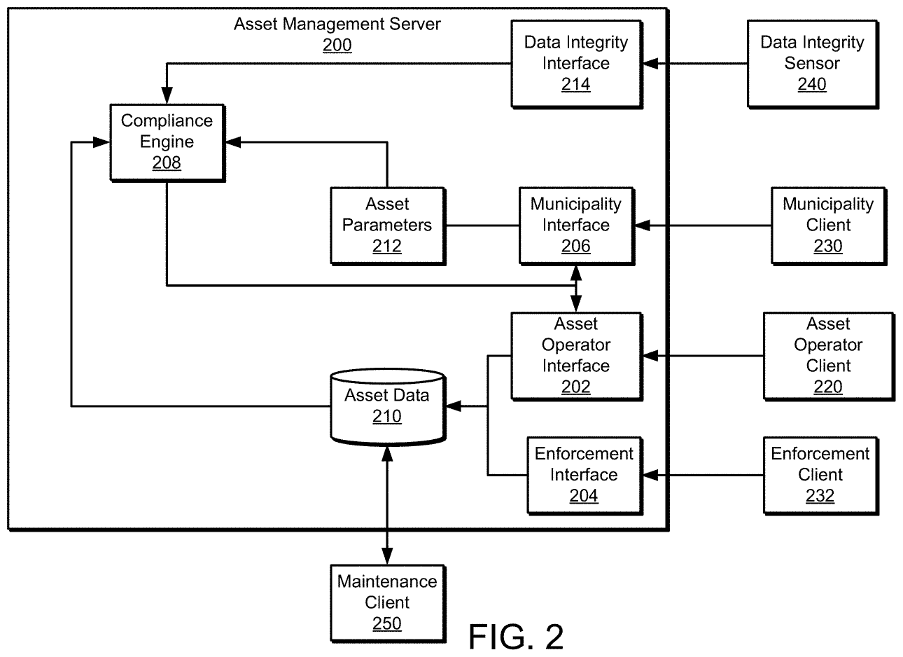

With further reference to FIG. 2, an example of an asset management server 200 is shown in greater detail. The asset management server 200 may include a number of communication interfaces. Each communication interface may interact with a network (e.g., the network 140 of FIG. 1 including a wide area network such as the Internet) to facilitate communication as described herein. Specifically, the asset management server 200 may include an asset operator interface 202. The asset operator interface 202 may communicate with an asset operator client 220 at each asset operator 120 of the plurality of asset operators described above in FIG. 1.

The asset operator client 220 may include a locally executed interface at an asset operator that is configured for communication with the asset operator interface 202. For instance, an application programming interface (API) may be provided to facilitate communication between the asset operator interface 202 and the asset operator client 220. In alternative examples, the asset operator client 220 may include a locally executing application such as a specifically configured application or an Internet browser that establishes communication with the asset operator interface 202. The asset operator interface 202 and the asset operator client 220 may be in bidirectional communication to provide real time or near real time information between the asset management server 200 and an asset operator. This may allow real time asset data 210 to be collected from the asset operator client 220. In addition, the asset operator client 220 may receiver real time information regarding an asset including, for example, whether the asset is compliant or noncompliant with asset parameters. Moreover, as described above guidance information (e.g., regarding available parking or other information to assist in achieving compliance with the asset parameters) may be provided to the asset operator client 220 in real time. In an example, the asset operator client 220 may provide information received from the asset operator interface 202 or information based on information received from the asset operator interface 202 to asset users via the asset operator's application (e.g., to provide guidance to parking or the like as described above).

In any regard, the asset operator client 220 may execute on a computing device of the asset operator to provide asset data from the asset operator to the asset operator interface 202. Further still, the asset operator interface 202 may support bidirectional communication with the asset operator client 220 such that information may be bidirectionally shared between the asset management server 200 and the asset operator client 220 as described in greater detail below. The communication between the asset operator interface 202 and the asset operator client 220 may allow for real time or near real time exchange of data between the asset management server 200 and the asset operator client 220

The asset management server 200 also includes an enforcement interface 204 which communicates with an enforcement client 232. As will be described in greater detail below, asset data may also be received from an enforcement client 232. The enforcement client 232 may comprise an application executing on a mobile device that may be used in the field to generate and communicate asset data to the asset management server 200. For instance, a municipality may deploy a mobile device including the enforcement client 232 to enforcement personnel such as traffic enforcement officers. Additionally or alternatively, the enforcement client 232 may be provided to other users to assist in documenting asset data (e.g., assets in non-compliance with an asset parameter). In turn, the enforcement client 232 may utilize functionality of the mobile device (e.g., a user interface, camera, or the like) to obtain asset information for assets in the field such as assets that are in non-compliance as determined by the enforcement personnel or other users of the enforcement client 232. For instance, a camera device may be used to capture a unique identifier of an asset and/or pictures of the asset in non-compliance. In any regard, the enforcement client 232 may communicate asset data to the enforcement interface 204 of the asset management server 200. The enforcement client 232 may be in bidirectional communication with the enforcement interface 204. For instance, and as described in greater detail below, the enforcement interface 204 may receive information from a compliance engine 208 of the asset management server 200. In turn, the enforcement interface 204 may provide information to the enforcement client 232 (e.g., for display on a device executing the enforcement client 232). Such information may include information regarding an asset identified by the maintenance client 232 including whether the asset has already been reported, whether the asset is in fact in non-compliance, or other information without limit.

The asset management server 200 also includes a municipality interface 206 which communicates with a municipality client 230 (e.g., in bidirectional communication). The municipality client 230 may facilitate communication between a municipality and the asset management server 200. In an example, the municipality client 230 may be a communication interface of a municipality server or other computing device. For instance, an API may be established to facilitate bidirectional communication between the municipality client 230 and the municipality interface 206. Alternatively, the municipality client 230 may include a web browser or other software application that allows municipal users to access the asset management server 200 by way of the municipality interface 206. In turn, the communication between the municipality client 230 and the asset management server 200 may facilitate receipt of information from the municipality client 230 regarding asset parameters 212 and/or may allow the municipality client 230 to access asset data 210 including compliance data regarding the assets of the asset operators. For example, the municipality client 230 may access compliance logs, citation reports, or other data generated by the centralized asset management system (e.g., the compliance engine 208) regarding the compliance or non-compliance of assets and/or asset operators.

In one example, the municipality client 230 may provide to the municipality interface 206 information in text form such as ordinance language, contractual language, or the like. In turn, the asset management server may use natural language processing to parse the ordinances and may automatically generate asset parameters 212 based on the parsed and processed text information.

The asset management server 200 may also receive maintenance information regarding one or more assets from a maintenance client 250. The maintenance information may be stored in connection with assets in the asset data 210. For instance, the asset parameters 212 may include maintenance rules that define maintenance procedures and/or intervals applicable to the assets. The maintenance client 250 may provide information regarding the performance of maintenance on an asset that can be compared against maintenance rules in the asset parameters 212 to determine if maintenance is needed on an asset. Specific asset parameters related to maintenance rules are described in greater detail below. However, the maintenance client may receive indication of maintenance that may need to be performed on the asset and may record completion of needed maintenance. In one example, the maintenance client may be integrated into an asset operator application for use by, for example, asset operator personnel when performing maintenance on assets. The maintenance client 250 may also receive information from the compliance engine 208. For instance, the compliance engine 208 may provide information regarding maintenance required for an asset to bring the asset into compliance or may respond to a request regarding maintenance status or required maintenance for an asset.

The asset management server 200 includes a datastore including asset data 210. The asset data 210 may include any or all data received at the asset management server 200 regarding the assets in a given area (e.g., a given municipality). For instance, the asset data 210 may be received from the asset operator client 220 via the asset operator interface 202 as described above, from the enforcement client 232 via the enforcement interface 204, and/or the maintenance client 250.

The asset management server 200 also includes one or more asset parameters 212. For instance, the asset parameters 212 may be at least partially defined by a municipality client 230 accessing the asset management server 200 by way of the municipality interface 206. The asset parameters 212 may include definitions regarding the location, operation, or other condition to be applied to assets operating in a given area. The definitions of the asset parameters 212 may include positively defined conditions (e.g., assets may be located in a given geographic area) or negatively defined conditions (e.g., assets may not be located in a given geographic area). Further examples of asset parameters 212 that may be employed to determine asset compliance based on received asset data 210 is described in greater detail below.

The asset management server 200 also includes a compliance engine 208 as briefly noted above. The compliance engine 208 may access the asset data 210 and the asset parameters 212 to determine if the asset data 210 for each asset complies or does not comply with the asset parameters 212. The compliance engine may also provide data to the asset operator interface 202 to allow for compliance data to be provided to asset operators via the asset operator client 220. For example and as described above, the compliance engine 208 may provide a message to an asset operator interface 202 for communication to the asset operator client 220 in real time or near real time. The message may include warning notices for non-compliance of an asset, warning notices with a specified grade period to rectify the non-compliance of an asset, notices of non-compliance that have been rectified, and/or notices of fines accessed for non-compliance. The compliance engine 208 may also provide data to the municipality interface 206 to allow for compliance data to be provided to a municipality via the municipality client 230 as described above. Further still, the compliance engine 208 may also provide information to an enforcement interface 204 for communication to an enforcement client 232. The compliance engine 208 may also communicate to a maintenance client 250 as described above.

Furthermore, the asset management server 200 may receive field data regarding one or more assets that are physically observed in the one or more geographic areas in which compliance is monitored. Specifically, a data integrity sensor 240 may provide such field data regarding physically observed assets. The field data may be collected by any appropriate sensor that may identify an asset. Examples include, but are not limited to, machine vision systems, LIDAR sensors, scanners, or other sensors capable of identifying an asset. The data integrity sensor 240 may be statically mounted (e.g., within the observed areas such as on light posts, signs, or other stationary mounting points). Alternatively or additionally, data integrity sensors 240 may be mounted on mobile platforms such as land vehicles, air vehicles, or the like. In an example, the vehicle to which the data integrity sensor 240 is mounted may be an autonomous vehicle.

The field data from the data integrity sensors 240 may be received at the asset management server 200 where it is ingested a data integrity interface 214. The field data may be communicated to the compliance engine 208. The field data may include metadata regarding the asset observed that may be processed by the data integrity interface 214 to associate with a physically observed asset information such geo-location data, time and day of the observed asset, orientation of the asset, or other information. Moreover, the asset operator of the asset may be identified using machine learning or the like.

The compliance engine 208 cross checks the field data against the asset data 210 received from the asset operators client 220 and the enforcement client to determine if the field data matches the asset data 210. In this regard, if an asset operator is misreporting asset data to the asset management server 200, the asset management server 200 may use the received field data from the data integrity sensor 240 to determine such misreporting. For example, an asset operator may provide limited data on their asset fleet in an attempt to circumvent asset caps or the like. However, if assets are identified by the data integrity sensor 240 that do not have matched asset data 210, it may be discovered that the asset operator is not in compliance with asset parameters 212 regarding data integrity. This may result in any appropriate action in relation to non-compliance described above.

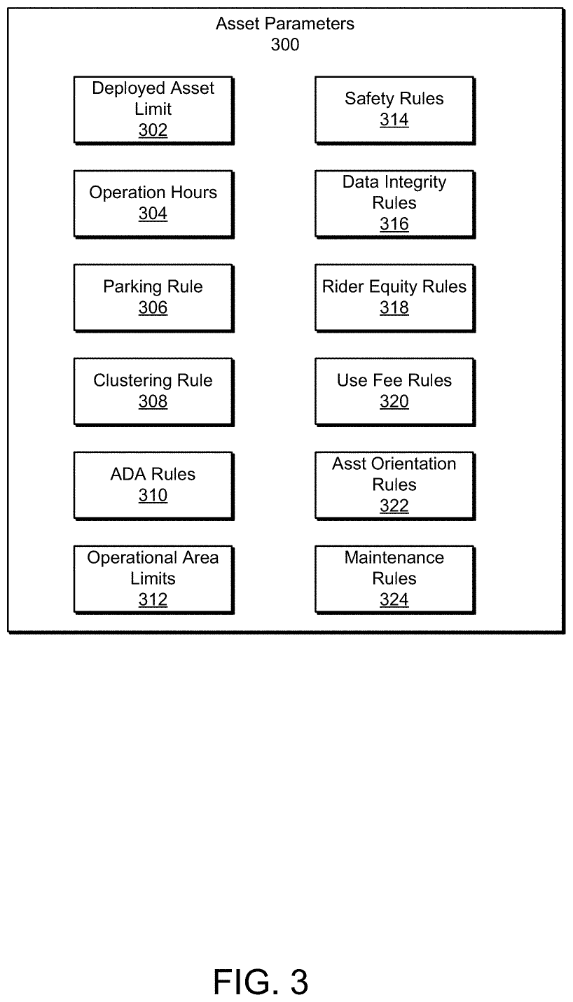

FIG. 3 includes an example of asset parameters 300 that may be provided to an asset management system for use in determining compliance or non-compliance of assets based on received asset data. The asset parameters 300 described in FIG. 3 are exemplary and not intended to limit the scope of the disclosure in any way. Therefore additional or fewer asset parameters 300 may be provided without limitation.

The asset parameters 300 may include a deployed asset limit 302 that defines the maximum number of assets that may be deployed (e.g., an asset cap). The deployed asset limit 302 may be applicable to individual asset operators or may be a global limit on the number of assets in a given geographic area. It is further contemplated that as an optional enforcement feature a notice may be generated (e.g., by a compliance engine 208) and provided to an asset operator informing the asset operator that the asset operator will be non-compliant and the fleet size of the asset operator is or will be dynamically reduced for a specified period of time as described in greater detail below. This may also be used to inform an operator that the operator can increase the operator's asset cap (e.g., dynamically in view of compliance of the asset operator, addition of private parking, or any other trigger).

The asset parameters 300 may also include operation hours 304 that define times in which assets may operate in a given geographic area. The operation hours may be globally defined for all assets in an area, may be applied individually to asset operators, or may be applied based on asset type.

The asset parameters 300 may also include parking rules 306. The parking rules 306 may positively or negatively define areas for parking of assets (e.g., between asset deployments in the case of ADDs or at the conclusion of a ride in the case of DMVs). As will be illustrated in greater detail below, the parking rules 306 may include generic rules applicable to all public infrastructure in a given area. Moreover, the parking rules 306 may include specific geographic definitions that either define where assets may be parked or where assets may not be parked. A number of ways of defining such geographic definitions may be provided as will be described in greater detail below in relation to example interfaces for an asset management system. The parking rules 306 may also include a parking fee (e.g., fees assessed to operators for parking on the public infrastructure). The parking fee may be static or dynamic. If dynamic, the parking fee can be based on any number of factors (which may or may not be interdependent) including, but not limited to time of day, location, demand, etc.

The asset parameters 300 may also include clustering rules 308. The clustering rules 308 may define a given maximum asset density for a given area. The clustering rule 308 may seek to prevent overcrowding of assets in any one location. The clustering rules 308 may define maximum asset densities for a given asset operator, a given asset type, or globally across all asset providers.

The asset parameters 300 may also include Americans with Disabilities Act (ADA) rules 310. The ADA rules 310 may define statutorily defined requirements related to public infrastructure that define the manner in which assets may be utilized or areas in which assets may be located.

The asset parameters 300 may also include operational area limits 312. The operational area limits 312 may define geographic areas in which assets may operate for a given municipality or other geographic area. Furthermore, the operational area limits 312 may define area in which assets are prohibited from being located while parked and/or while in operation.

The asset parameters 300 may also include safety rules 314. The safety rules 314 may defined required safety inspections and/or safety conditions related to an asset. For instance, as described above, mechanisms may be provided for helmet enforcement which may be provided in the safety rules 314.

The asset parameters 300 may also include data integrity rules 316 that relate to data integrity of asset data provided by asset operators. For instance, rules regarding the uptime of the data connection between asset operators and the asset management server may be defined to ensure that asset operators continue to provide up to date (e.g., real time) information to the asset management system. The data integrity rules 316 may also define acceptable limits regarding the accuracy of asset data provided by the asset operators, which may be verified using data integrity confirmation approaches described above.

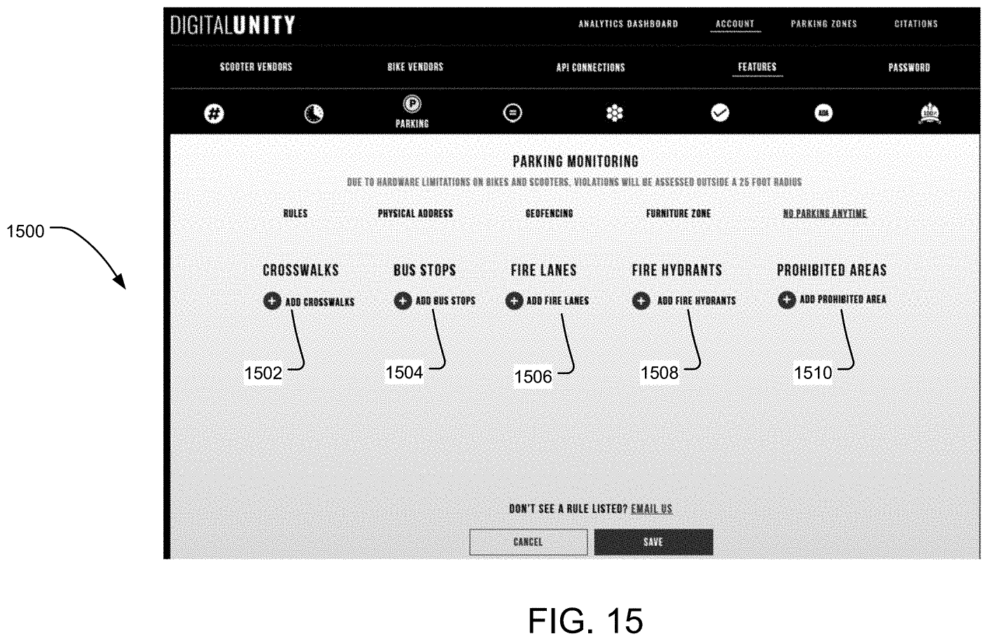

The asset parameters 300 may also include rider equity rules 318 that relate to the equitable distribution of assets in municipal-defined zones, assuring the city that the defined number of assets are present, upon the specified time period in FIG. 15. Notices sent bilaterally via 220.

The asset parameters in 300 may also include use fee rules 320 that may define a fee to be collected by a municipality. The use fee may be defined as a percentage of the fee for each asset use assessed to a user or may be a surcharge fee applied to each ride. Use fees may be dynamic and change with any number of factor including time, location, demand, etc.

The asset parameters in 300 may also include asset orientation rules 322 that define that assets be parked in a certain configuration (e.g., upright). In turn, asset data may include accelerometer data from an asset to determine an asset orientation.

The asset parameters in 300 may also include maintenance rules 324 that may define regularly scheduled maintenance required for assets. The maintenance rules 324 may include, but not be limited to checks related to brake functionality, tire pressure, reflector presence, state of handlebars (e.g., tightness, presence of damage, instruction stickers, etc.), headset bearing state, full handlebar range of motion, bell presence/function, battery damage/wear, lights, test ride, and cleanliness of the asset. The maintenance rules 324 may define interval at which each check or all checks must be performed.

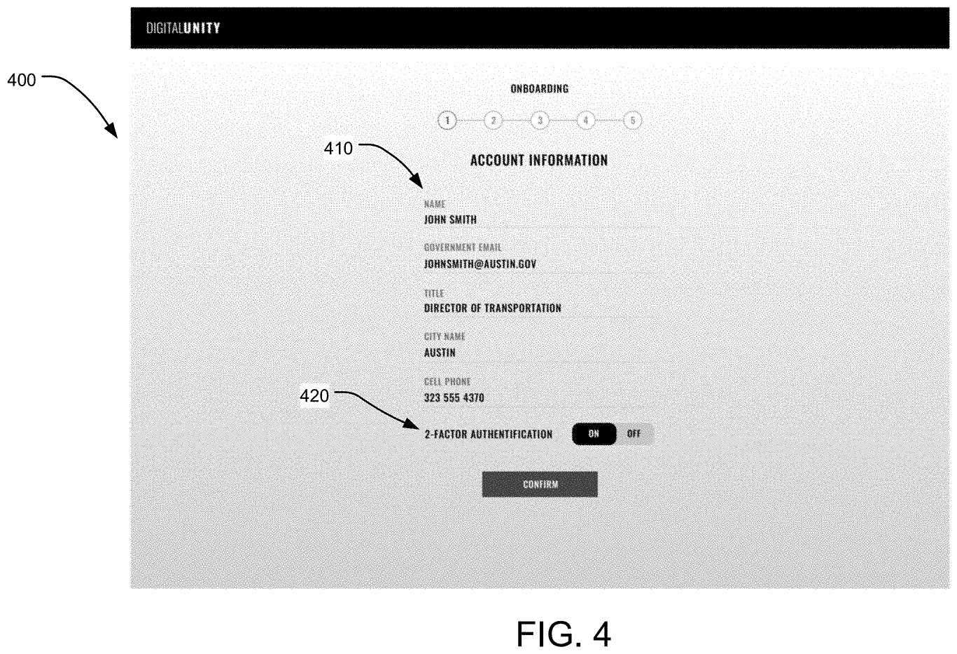

FIGS. 4-24 present example interfaces for an asset management system that may allow for interaction with the system by municipality users, asset operator users, or other users to access features of the system and/or control functions of the system.

For instance, FIG. 4 depicts a user onboarding screen 400. The user onboarding screen 400 may allow a user to register for access to the asset management server. In this regard, the user onboarding screen includes user data prompts 410 that allow a user to enter account information including a username, user email, title, city affiliation (if any), asset operator affiliation (if any), and/or contact information. In this regard, while the onboarding screen 400 relates to a municipality user, a common or distinct onboarding screens for other users (e.g., private landowners, enforcement client users, data integrity users, etc.) may be provided without limitation. The user onboarding screen 400 may also include a security option 420 to allow the user to select certain security parameters for the user's account including, for example, whether to utilize two-factor authentication or the like.

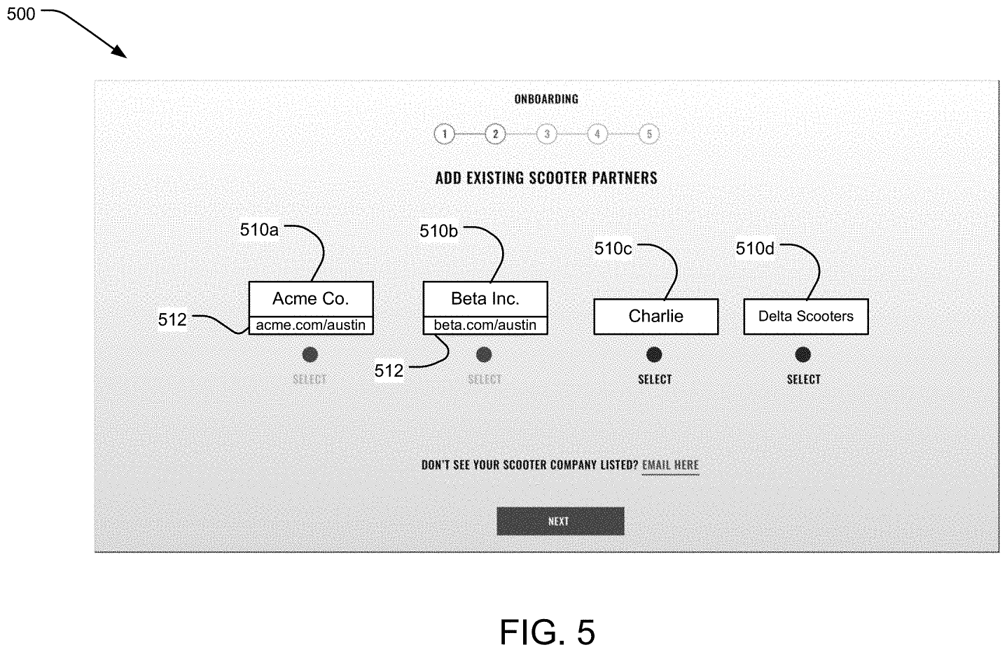

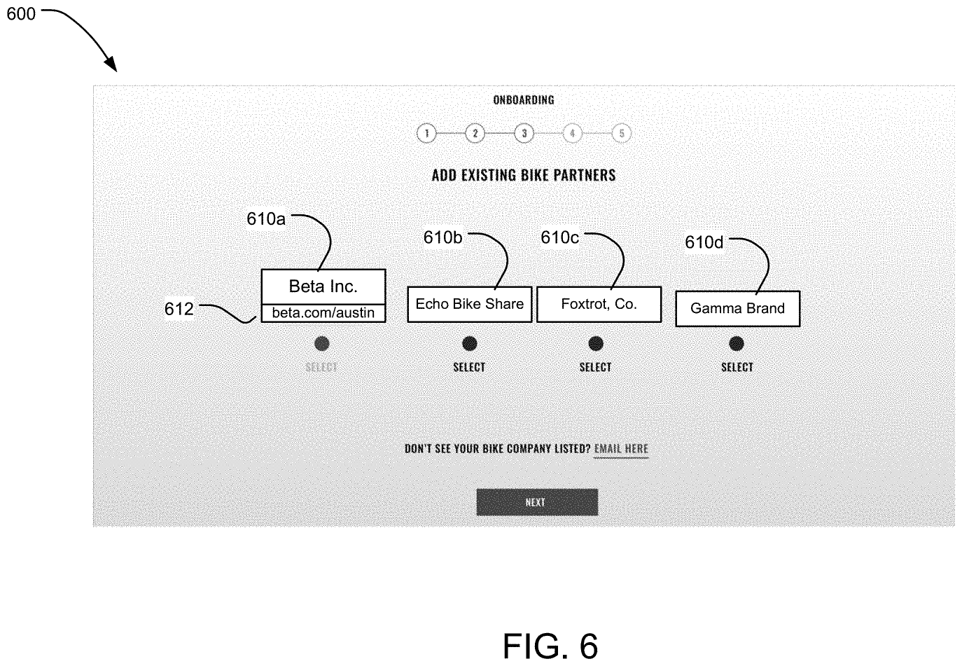

Once the user confirms the account information provided on the user onboarding screen 400, an asset partner selection screen 500 may be presented to the user. The asset partner selection screen 500 may present asset operator selections 510a, 510b, 520c, 510d, 510e and allow a user to select which of the asset operators are authorized to operate in the municipality of the user registering. While four asset operators 510a-510d are depicted in FIG. 5, additional or fewer asset operators may be displayed for selection by a user. Moreover, a user may be presented with a button 510e to add a new asset operator. Upon selection of one or more asset operators, a user may be presented with an input box 512 that allows the user to provide an address for use in connecting with the asset operator selected with API based credentials or similar. For instance, an address associated with an asset operator client may be provided to allow the asset management server to connect to and receive asset data from each respective asset operator (e.g., through an API). While the partner selection screen 500 allows a municipality user to select a first asset type partner (e.g., scooter providers), additional partner selection screens such as partner selection screen 600 (shown in FIG. 6) may be provided to allow for selection of other asset operators for different asset types. In this regard, the partner selection screen 600 may allow asset providers that provide bikes rather than scooters or other DMVs and/or ADDs without limitation. Like partner selection screen 500, partner selection screen 600 may list asset operator selections 610a, 610b, 610c, and 610d. Upon selection of an asset operator, an input box 512 may be provided for connecting with the asset operator selected. Moreover, a user may be presented with a button 610e to add a new asset operator.

As may also be appreciated, a given asset operator may provide multiple asset types. For instance, Beta Inc., may operate both scooters and bikes. In turn, Beta Inc. may host different APIs for providing information regarding their scooters and bikes respectively. Alternatively, upon selection of a given asset operator, all types of assets may be included in the asset data provided without having to register each asset type separately.

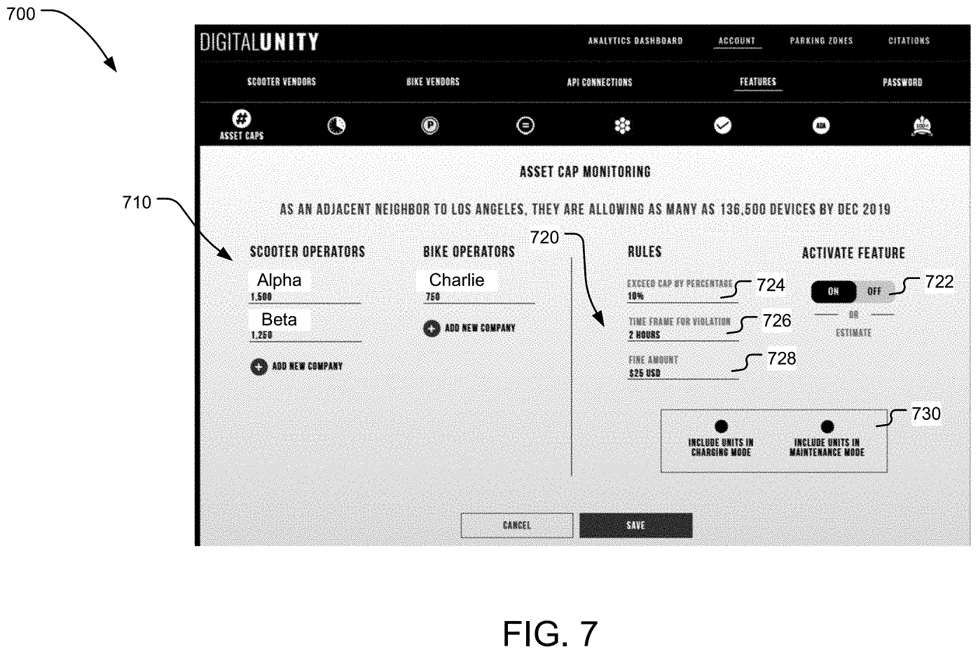

FIG. 7 depicts an example of an asset cap monitoring setup screen 700. The asset cap monitoring set up screen 700 may allow the user to establish one or more deployed asset limits to be included in the asset parameters for the asset management system for the municipality of the municipality user. The asset cap monitoring set up screen 700 includes a cap definition area 710. The cap definition area 710 may list each asset operator established for a given asset type to be operated in the municipality. As can be appreciated, asset types are shown separately, although a given asset operator may operate multiple types of assets. The cap definition area 710 may list each asset operator and allow a user to enter a cap value for each operator of each data type. The cap definition area 710 may also allow a user to add a new asset operator for each asset type by selection of the “ADD NEW COMPANY” button listed for each asset type.

The asset cap monitoring setup screen 700 may also provide a global deployed asset limit area 720 that may allow for selection of global asset cap parameters applicable to each asset operator. Initially, a global selection 722 for enforcement of asset caps may be provided to globally enable or disable asset cap monitoring. Additionally, a definition 724 of the amount by which caps may be exceeded without triggering non-compliance may be provided. Moreover, a period selection 726 over which the asset cap must be exceeded prior to triggering non-compliance may be provided. Furthermore, the user may be able to establish a fine amount 728 for each occurrence of non-compliance of the asset cap rules. The global asset cap rule area 720 may also include a selection 730 of what assets are to be included for determining whether a cap has been exceeded including designation of whether charging assets or assets in maintenance are considered. Once complete, the user may save the selections from the asset cap monitoring setup screen 700 to be saved as asset parameters for use by the asset management server to monitor asset compliance to the asset parameters.

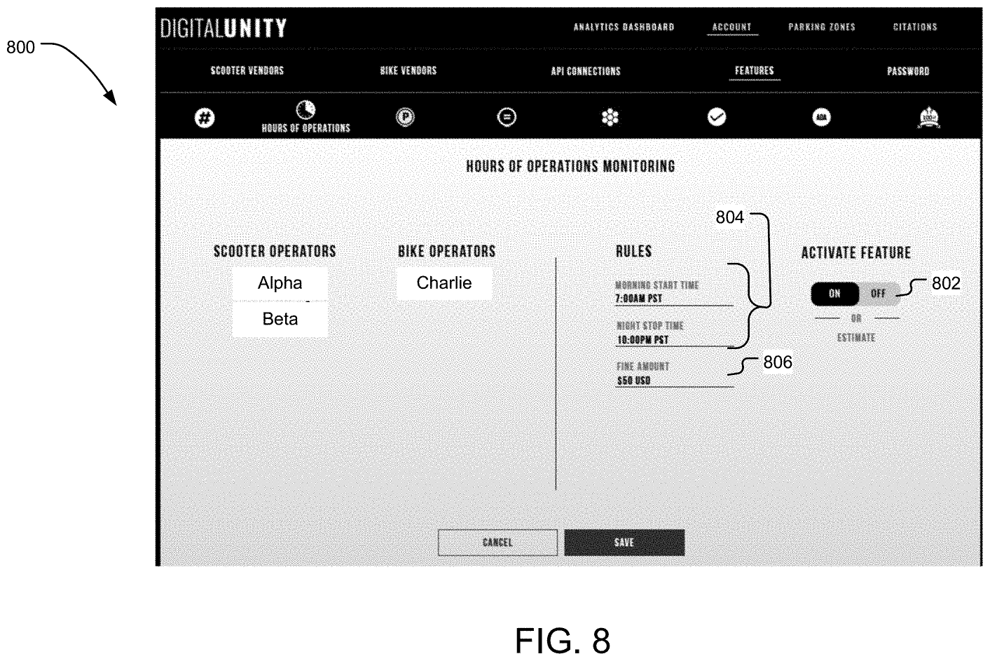

The asset parameters may also include operational hours rule. FIG. 8 depicts an hours of operation selection screen 800. The hours of operation selection screen 800 provides a global selection 802 for application of the operational hours rule to assets. Moreover, the hours of operation selection screen 800 allows for designation of operational hours 804 and a fine 806 associated with non-compliance. Once completed, the asset parameters regarding the operational hours rule may be saved to the asset management server and used in determining compliance or non-compliance relative to asset data.

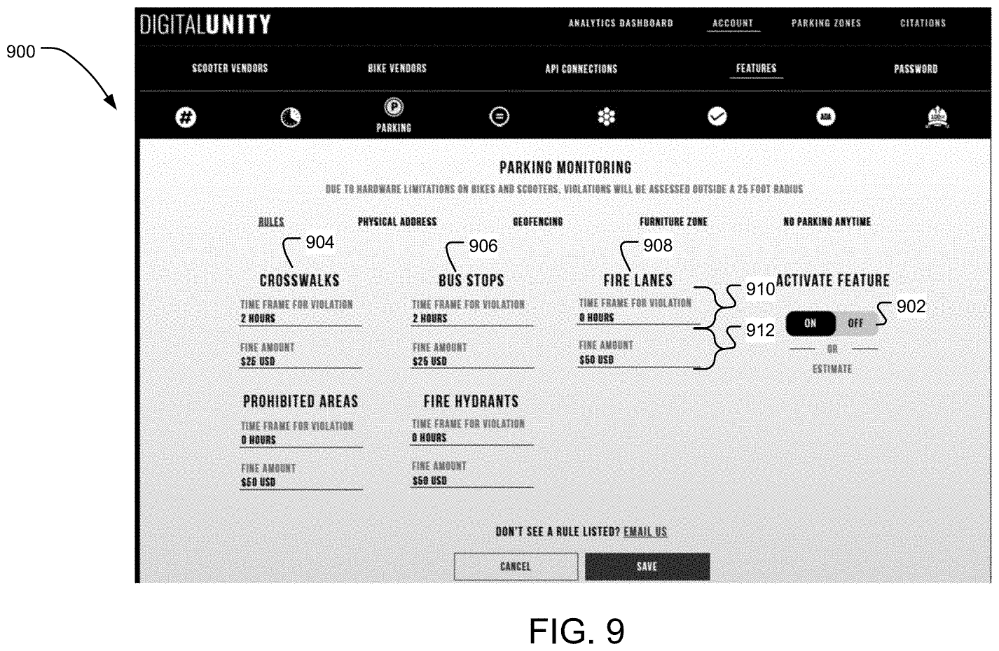

FIG. 9 depicts a parking rules screen 900. The parking rules screen 900 includes a global selection 902 of application of parking rules. The parking rules screen 900 also include rule definition areas 904, 906, 908 for defining rules related to each of crosswalks, bus stops, fire lanes, prohibited areas, and fire hydrants, respectively. Specifically, a user may establish a violation duration 910 that must be exceeded prior to being in non-compliance and a fine amount 912 associated with non-compliance in parking in each defined area.

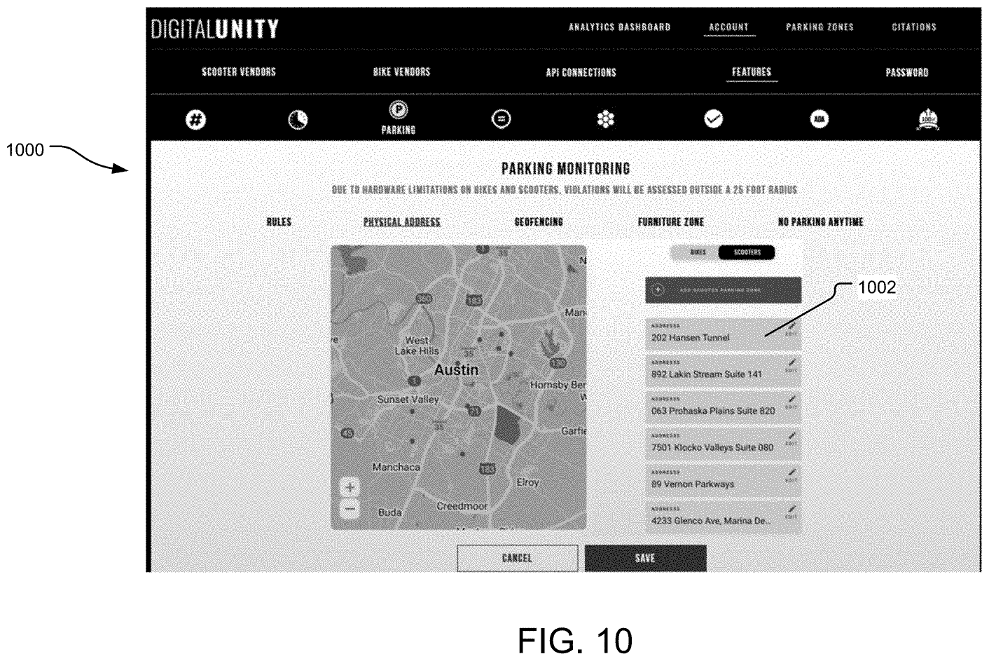

FIG. 10 depicts a parking area definition screen 1000. The parking area definition screen 1000 allows a user to define parking areas for assets. Specifically, defined parking areas may be provided by asset type by selection of either scooters or bikes. Once the appropriate asset type is selected, a physical address 1002 may be defined for a parking area.

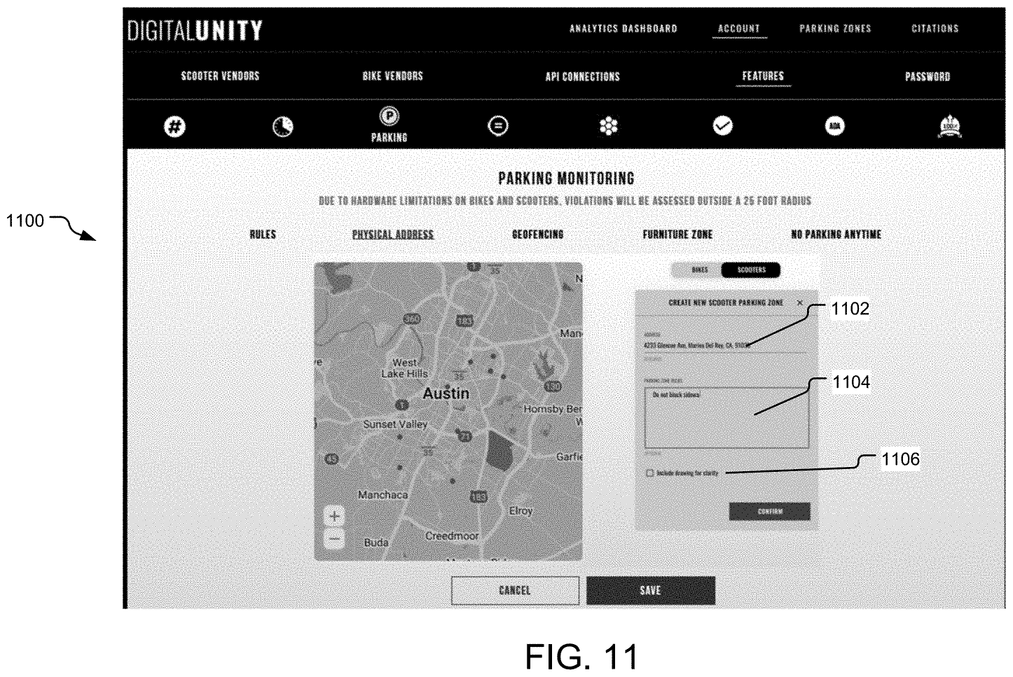

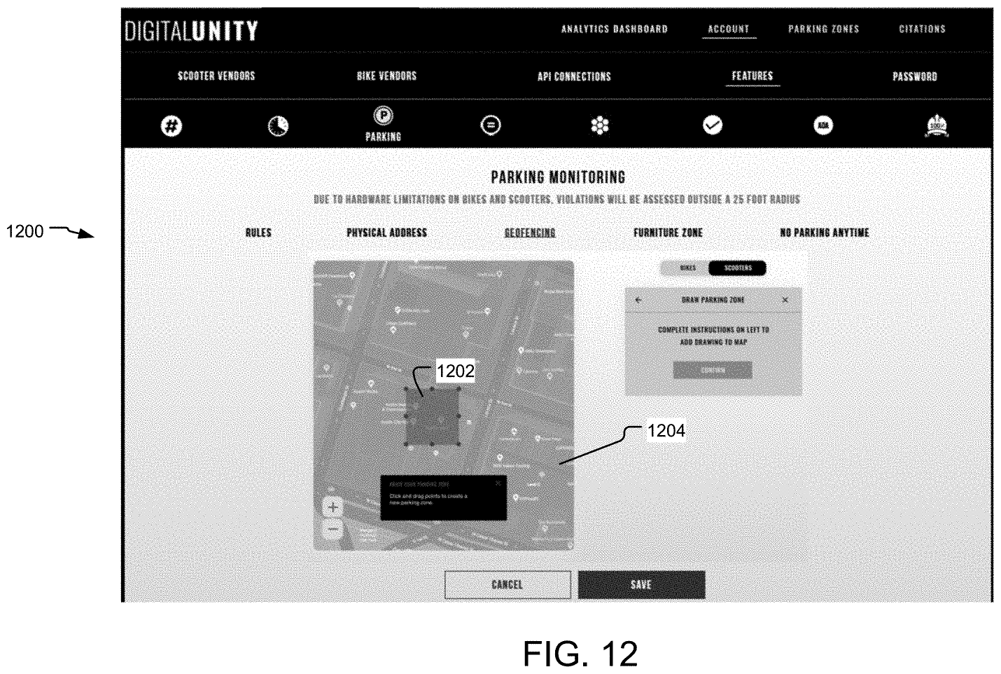

FIG. 11 depicts a parking area definition screen 1100 in which a user may input an address for a new parking area for a given asset type. The address 1102 of the parking area is input and any comments 1104 regarding the area may be provided. Moreover, there is a selection 1106 for adding a drawing for clarifying the extent of the parking area. Upon selection of this option, the user may be presented with a geofencing definition screen 1200 as shown in FIG. 12. Using this tool, a user may define a polygon 1202 relative to a map 1204 that defines a geographic area for the parking area to be established. Once defined by the user the parking areas may be saved as parking rules for inclusion in the asset parameters to be applied to asset data to determine compliance or non-compliance with the asset parameters.

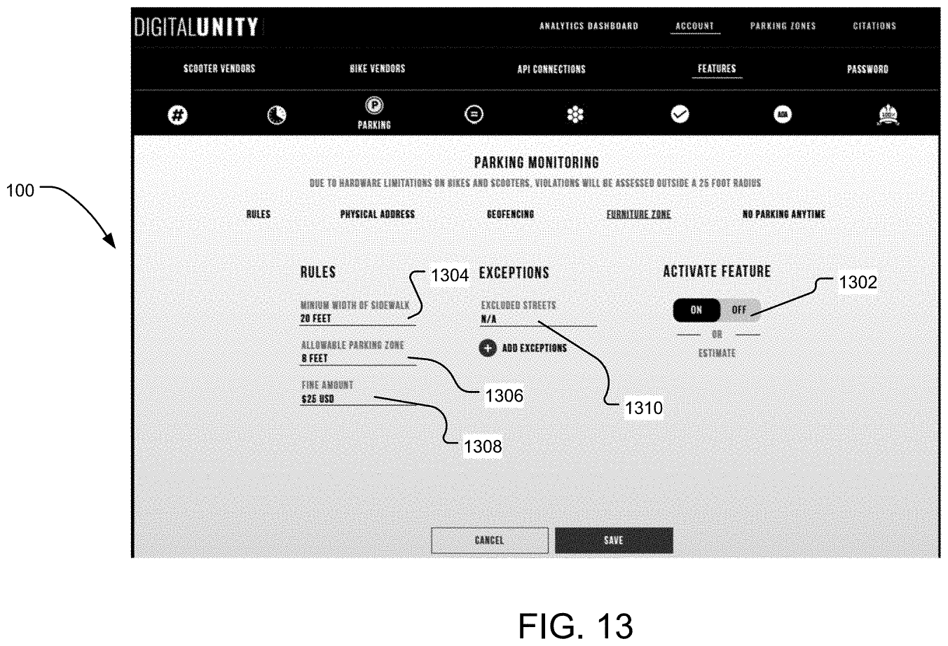

FIG. 13 depicts a furniture zone definition screen 1300. The furniture zone definition screen 1300 allows for definition of permissible parking of assets on public infrastructure. The furniture zone definition screen 1300 includes a global selection 1302 for enabling or disabling the application of the furniture zone parking rules defined in the screen 1300. The furniture zone definition screen 1300 also allows for definition of minimum sidewalk width 1304, allowable parking zone width 1306, and a fine selection field 1308 for defining the fine for non-compliance with the furniture zone parking rules. In addition, the furniture zone definition screen 1300 allows for excepted streets 1310 within a municipality to be provided for which the furniture zone parking rules do not apply.

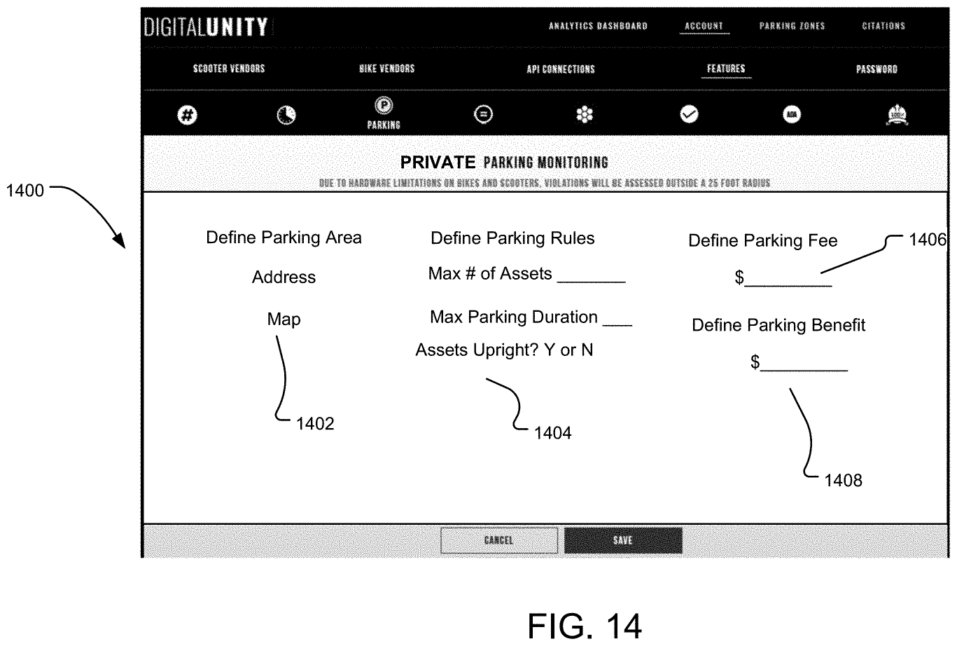

FIG. 14 depicts a private parking monitoring screen 1400. The private parking monitoring screen 1400 may be presented to a private landowner user to define parking availability on privately owned land. The private parking monitoring screen 1400 may include an area definition portion 1402 that may utilize any of the above-described approaches to defining a geographic area described for use by a municipality user without limitation. In addition, a private parking rule section 1404 may allow the private landowner to define rules applicable to the geographic area defined by the area definition portion 1402. While an asset cap, parking duration, and orientation rule are shown, additional or fewer rules may be applicable to the area defined by the private landowner without limitation. For example, any of the foregoing discussion regarding asset parameter definitions provided in relation to municipality users may be applicable to the private parking monitoring screen 1300 without limitation. The private landowner may also define a parking fee 1406 or a benefit 1408 for asset users who utilize the private land parking defined using the private parking monitoring screen 1400.

FIG. 15 depicts a parking prohibition selection screen 1500. The parking prohibition selection screen 1500 allows a user to define areas in which parking of assets is disallowed. Examples of areas that can be defined include crosswalks 1502, bus stops 1504, fire lanes 1506, fire hydrants 1508, and other prohibited areas 1510. Upon selection of the option to add a prohibited parking area, a user may define the area using any of the foregoing approaches to defining an area such as by physical address or defining a geofencing polygon on a map. In addition, each individual prohibited area may be associated with a given violation duration requirement and fine amount for non-compliance with any of the parking rules defined in the parking prohibition selection screen 1400.

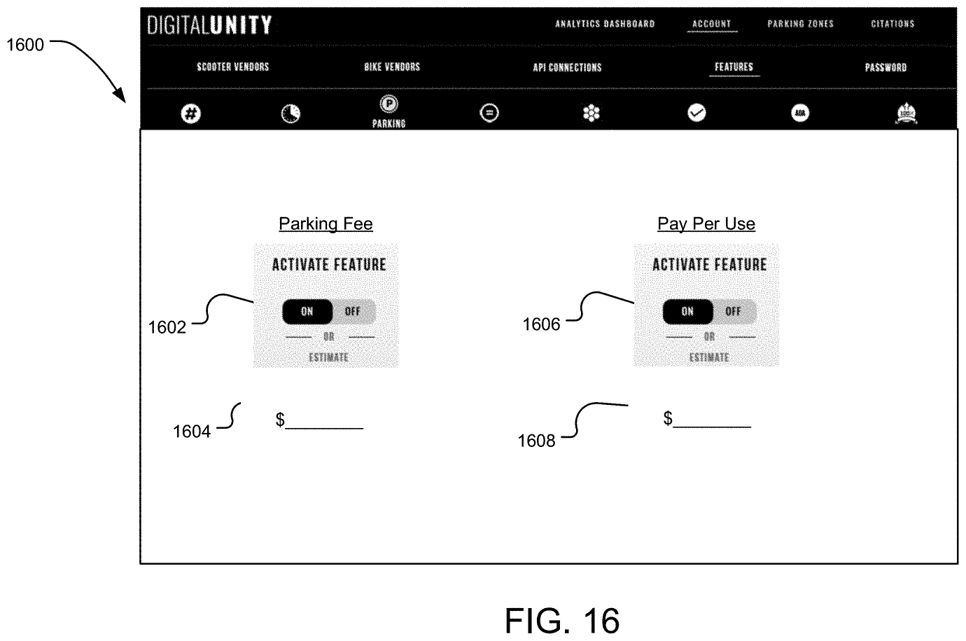

FIG. 16 depicts a fee selection screen 1600. This may allow a user to elect to impose a parking fee and/or a per-use fee. The fee selection screen 1600 includes a parking fee activation selection 1602 and a parking fee definition field 1604. The fee selection screen 1600 also includes a use fee activation selection 1606 and a use fee definition field 1608. It may be appreciated that fees may be imposed per area or in a dynamic fashion. As such, the screen 1600 depicted does not limit the scope described above in relation to such parking fees. In this regard, the fee selection screen 1600 may include additional interfaces that allow designation of fees to certain areas, definition of rules for dynamic pricing, or other additional interfaces to allow a user to customize the parking and/or use fee. The fee selection screen 1600 may be presented to municipality users and/or private land owner users without limitation.

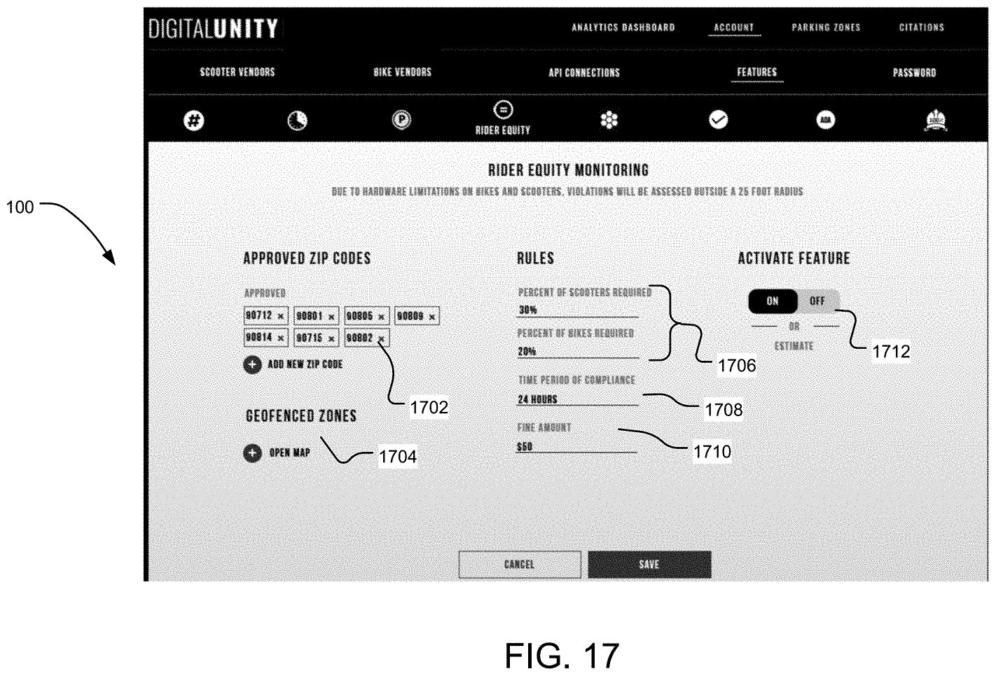

FIG. 17 allows a user to define rules regarding ride equity in a rider equity setup screen 1700. As more asset operators enter cities, rider equity, or the ability to offer rides at discounted rates in economically challenged areas becomes an important aspect of civic duty for asset operators. In order to help municipalities gain visibility to this important aspect of each asset operators operating agreement and enforce rider equity parameters, the asset monitoring server provides the ability to indicate areas of the city where: 1) a certain percentage of assets, per asset operator, need to be distributed to address equal opportunity and access to units and/or 2) when a rider commences a ride in the rider equity zone, the ride is discounted in some manner—by the initiation fee or the per minute fee.

The rider equity setup screen 1700 allows a municipality user to define rider equity zones using any of the foregoing approaches to area designation including without limitation physical address, drawing a polygon on a map, or by zip code as shown in FIG. 17. For example, the rider equity setup screen 1700 includes defined zip codes 1702 for which rider equity rules apply. Additionally or alternatively, a user may select a geofencing definition selection 1704 to define rider equity areas as described above in FIGS. 10-12. Once rider equity zones are established, a user may use selections 1706 on the rider equity setup screen 1700 indicate, by asset operator type, a certain number (or percentage of their city-wide fleet) of assets that must be present in these zones at all times. The rider equity setup screen 1700 also allows the user to define a period 1708 in which ride equity rules are enforced and a fine amount 1710 for non-compliance with the rules. The rider equity setup screen 1700 also provides a feature activation selection 1712 to globally activate and deactivate the applicability of the rider equity rules on the platform.

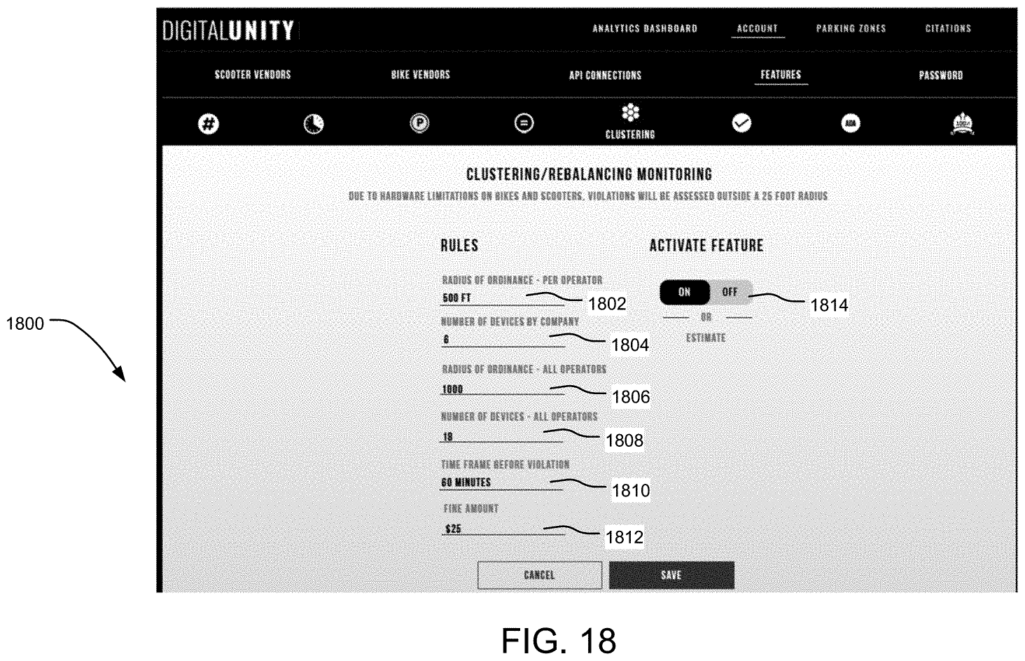

FIG. 18 includes a clustering rules screen 1800. The clustering rules screen 1800 allows a user to define clustering rules regarding maximum densities for assets in a given area to avoid problems associated with clustering or amassing of assets in a given area. The clustering rules screen 1800 allows a user to define a size of an area (e.g., the radius) 1802 in which the maximum number of assets may be present for a given individual asset operator. The clustering rules screen 1800 also allows a user to define the maximum number of assets of a given individual operator 1804 in the given size of area for an individual asset operator. The clustering rules screen 1800 also allows a user to define a size of an area 1806 (e.g., the radius) in which the maximum number of assets may be present for all asset operators in aggregate. The clustering rules screen 1800 also allows a user to define the maximum number of aggregated assets of all operators 1808 in the given size of area for all asset operators. The clustering rules screen 1800 also allows a definition of a time 1810 over which the asset parameter must be triggered prior to determining non-compliance. A user may further define a fine amount 1812 for non-compliance of the clustering rules. The clustering rules screen 1800 may also have a global selection 1814 for toggling applications of clustering rules on and off.

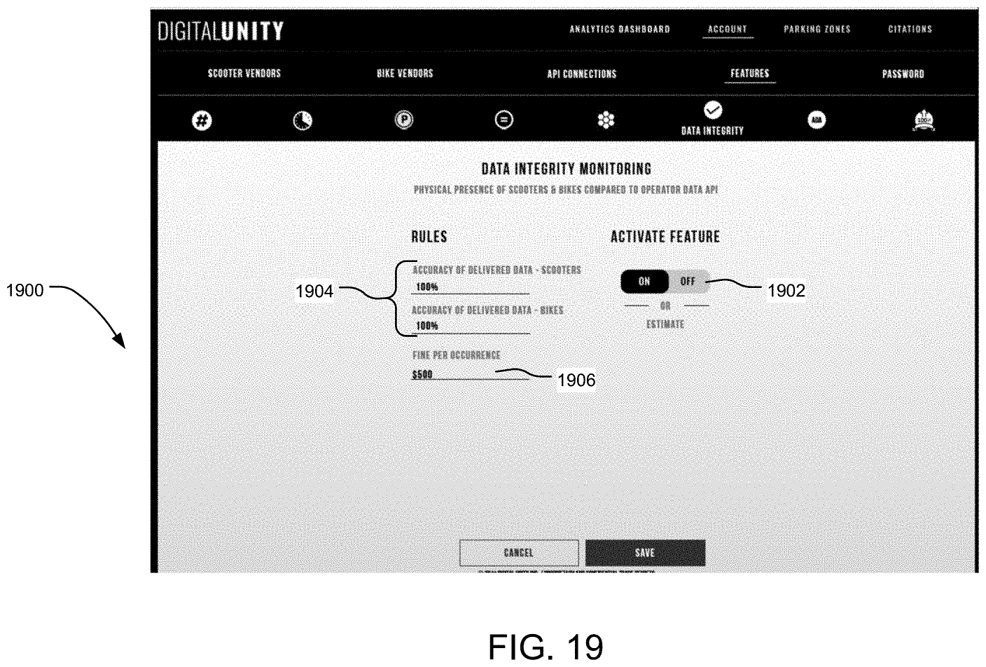

FIG. 19 depicts a data integrity monitoring screen 1900. As described above, to prevent an asset operator from supplying inaccurate data to the system, it is contemplated that the system could receive field data from a remote device that is configured to monitor real-time physical presence of assets at the street, sidewalk or airspace level to ensure data integrity.

In turn, the data integrity monitoring screen 1900 may define parameters regarding data integrity that must be complied with by asset operators. Specifically, the data integrity monitoring screen 1900 may allow a user to use a selection 1902 for global activation or deactivation of the data integrity parameters. Furthermore, the user may be able to define accuracy measures 1904 per asset type. Also, a fine amount 1906 per non-compliance may be established.

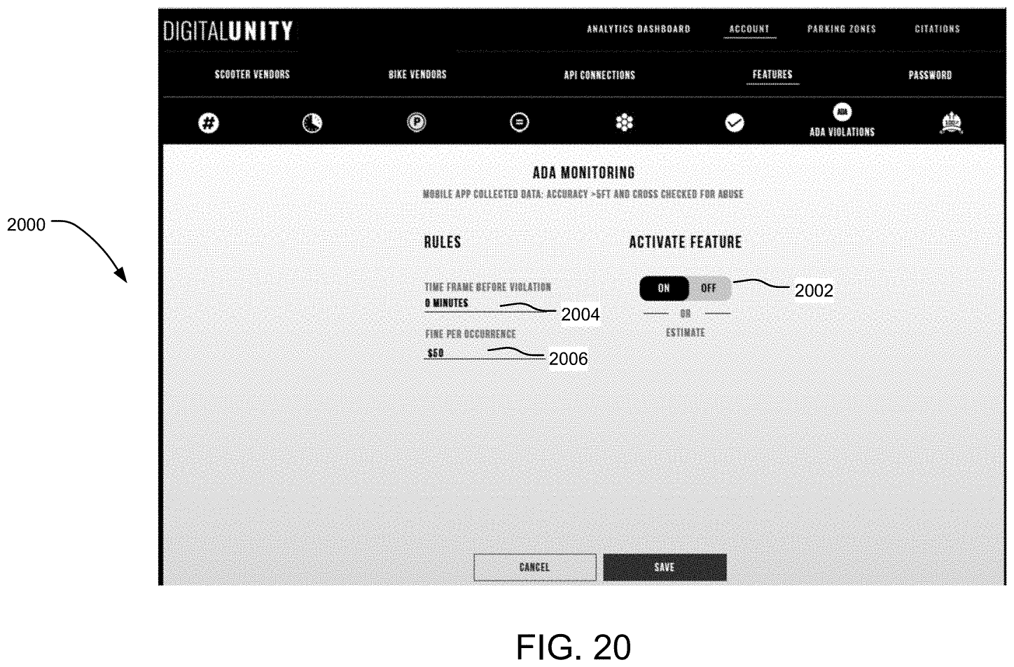

FIG. 20 depicts an ADA rules screen 2000. The ADA rules screen 2000 allows an operator to configure ADA rules for enforcement through the asset management system. The ADA rules screen 2000 includes a global selection 2002 that allow a user to select activation of ADA rules globally in the system. The user may also designate a duration 2004 after which a non-compliance is noted and a fine 2006 for each non-compliance.

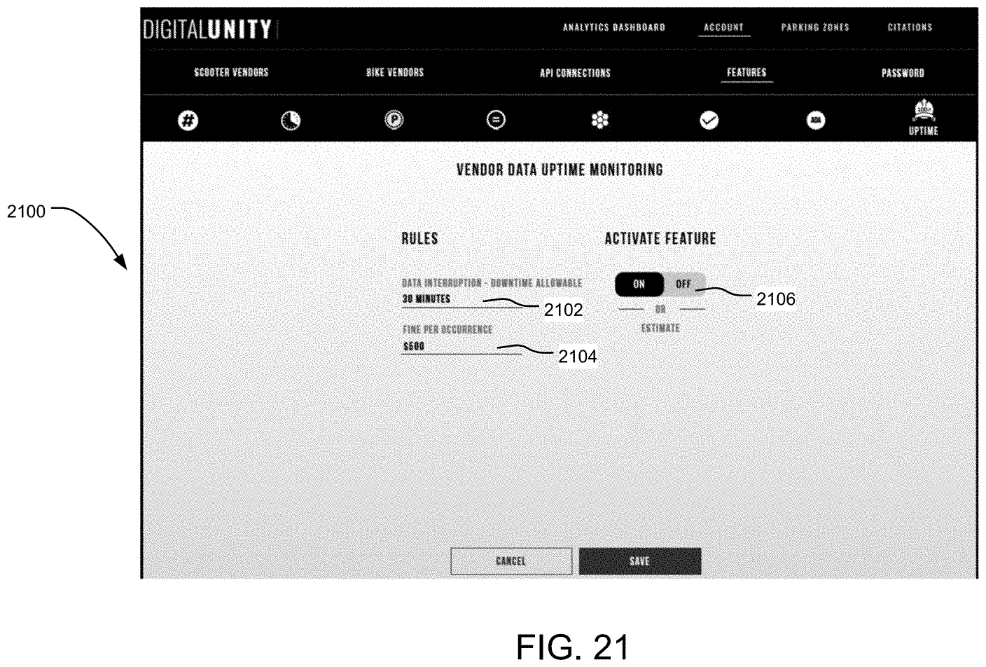

FIG. 21 depicts a data uptime rule screen 2100. The data uptime rule screen 2100 may allow a user to designate acceptable lengths of disruption 2102 of the real-time data feed between an asset operator and the asset management server. The data uptime rule screen 2100 may also allow for designation of a fine amount 2104 for non-compliance with the data uptime rule. A selection 2106 allows for enabling and disabling application of the data uptime rules in the system.

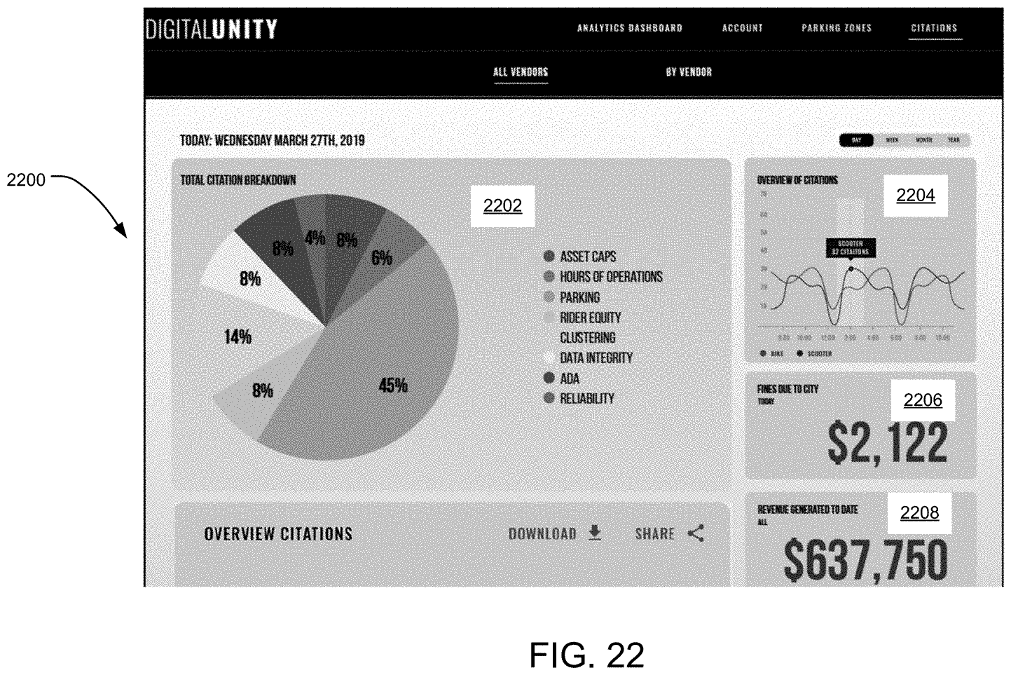

FIG. 22 depicts an enforcement dashboard 2200 that may be accessed by a municipality user to monitor the compliance status of assets in a municipality. The enforcement dashboard 2200 may be arranged to display statistics for all vendors or a user may select a specific vendor to filter the data presented to a given asset operator. The enforcement dashboard 2200 may include a citation overview area 2202 that may present a breakdown of the nature of non-compliance of assts. The enforcement dashboard 2200 may also have a historic citation level area 2204 that depicts the number of violations over a given time period. The enforcement dashboard 2200 may include a fines due area 2206 that indicates the total amount of fine revenue due to the municipality based on non-compliance and a revenue to date area 2208 that depicts the fine revenue to date.

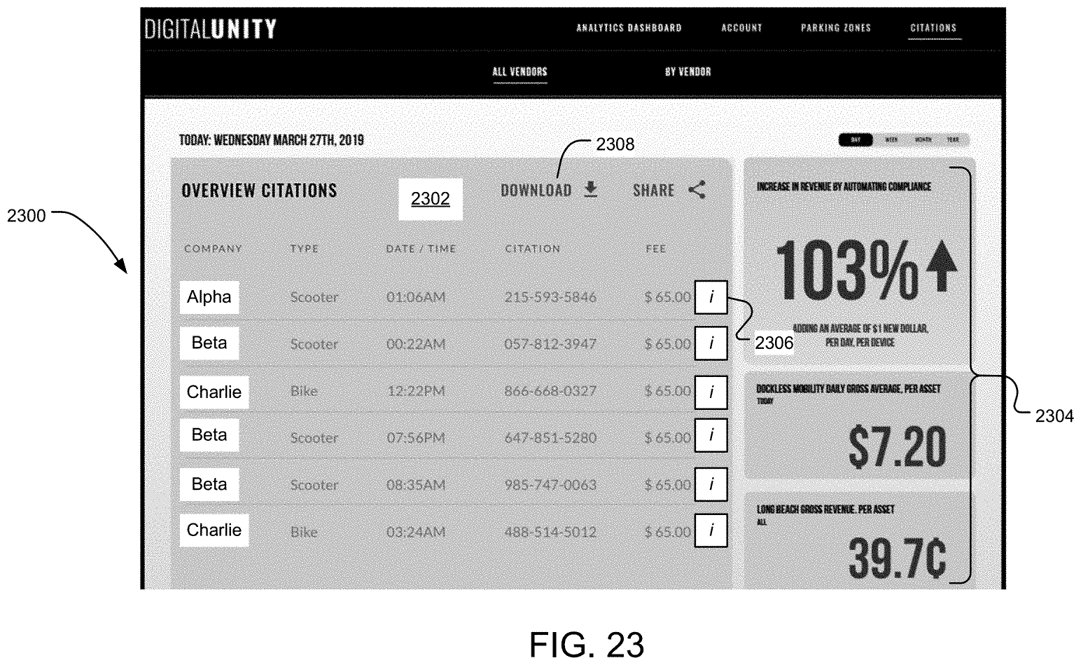

With further reference to FIG. 23, a enforcement dashboard 2300 is also depicted that may include a non-compliance log 2302 that lists non-compliance occurrences. The non-compliance log 2302 may be sorted by asset type, asset operator, or another filter. The non-compliance log may indicate the asset provider subject to the non-compliance, the asset type for the non-compliance, the date/time of the non-compliance, a citation number, and a fine amount for the non-compliance. The enforcement dashboard 2300 may also include a detail selection 2306 for each listing in the non-compliance log 2302. The detail section 2306 may provide or link to additional data related to the non-compliance of the asset in the non-compliance log 2306. This may include an image of the asset (if available, which may be obtained from an enforcement client during the non-compliance), details on how a fine was calculated, whether a warning was provided prior to assessing the fine, geolocation data and/or accuracy, or other detailed information. The enforcement dashboard 2300 may also include citation metrics 2304 including revenue change tracking, and gross daily revenue per asset. In addition, a download selection 2308 may be used to download all activity (e.g., a superbill) within a given period for an asset operator.

While FIGS. 22 and 23 are contemplated for municipality users to view compiled statistics regarding a municipality, similar dashboards may be provided to private landowners to view details regarding the private land managed by the private landowner using the asset management server. In this regard, parking revenue, non-compliance of assets, or other metrics may be tracked by a private landowner regarding one or more areas of privately owned land defined in the system.

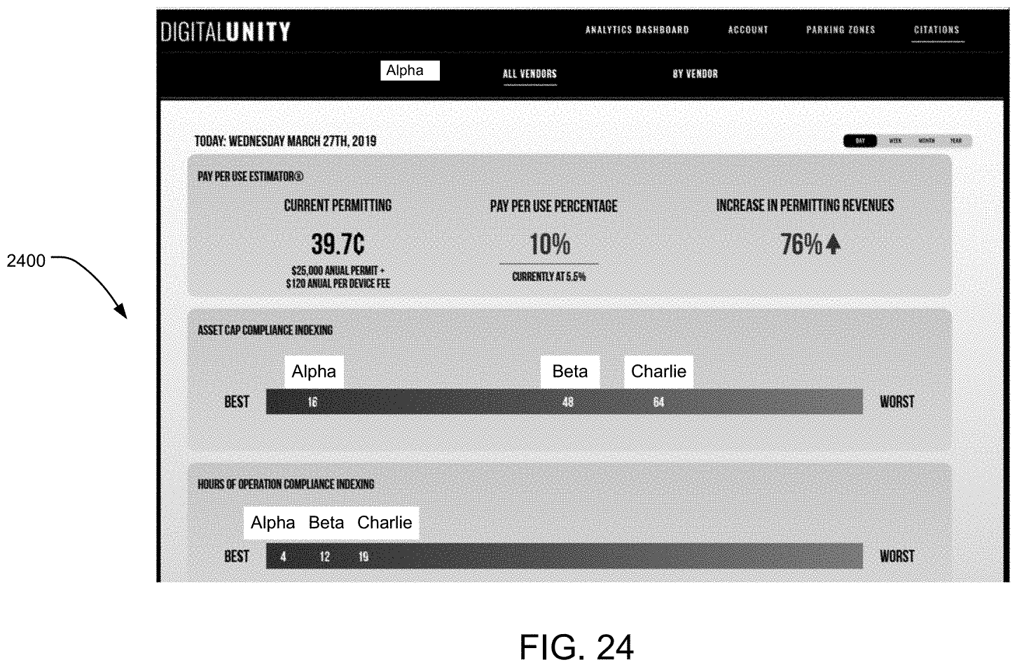

FIG. 24 presents another example of an enforcement dashboard 2400 that may provide revenue information in relation to a pay-per-use paradigm in which each use of an asset requires a fee to be paid to the municipality. Moreover, individual rule compliance metrics may be presented that depicts relative performance of asset operators relative to respective ones of the asset parameters.

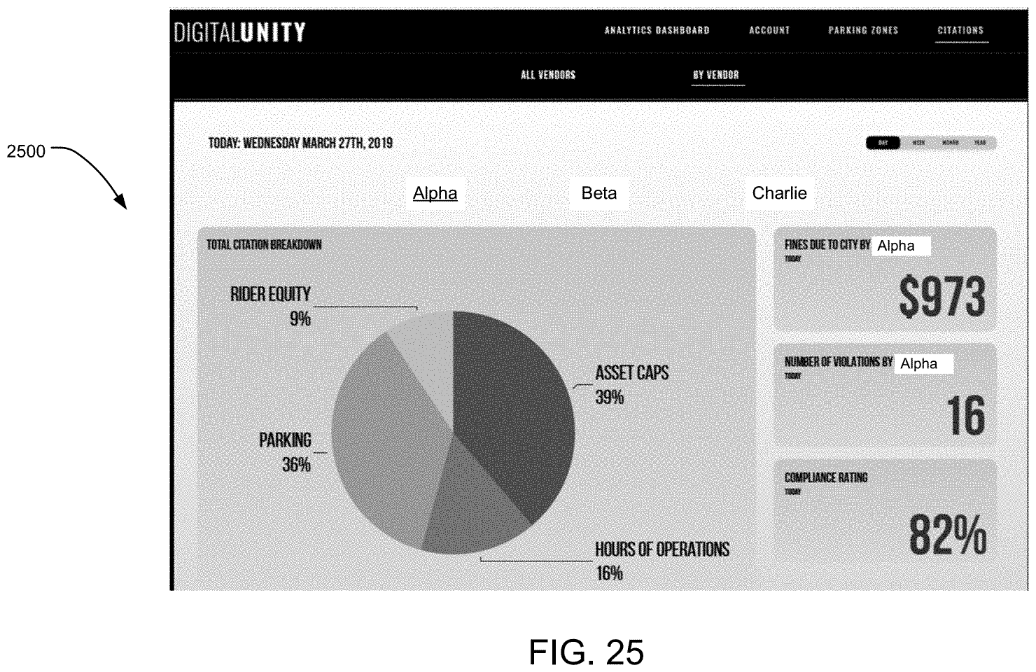

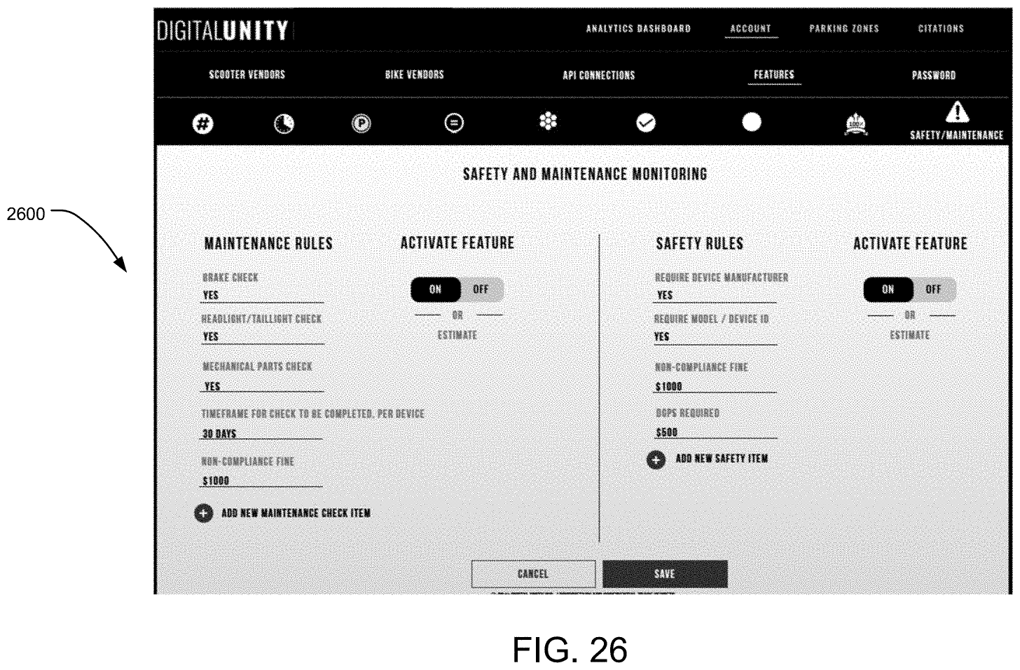

FIG. 25 depicts another example of an enforcement dashboard 2500, which may allow for filtering of the information presented based on asset operator or seen at an aggregate across all operators in a specified vertical (e.g., all scooter operators or all drone operators). The enforcement dashboard 2500 includes a citation breakdown, a total fines due, a total number of violations, and a compliance rating for a given asset operator selected by the user.

A user of the asset management system may also define safety and maintenance rules for assets operating in a municipality. This may assist in reducing risk associated with assets or the operation thereof. In this regard, a safety and maintenance screen 2600 is shown. The safety and maintenance screen 2600 may allow for a user to selectively activate or deactivate safety rules and maintenance rules globally. The maintenance rules may allow a user to define checks to be performed on an asset including a brake check, a headlight/taillight check, and a mechanical parts check. The maintenance rules may allow a user to define the frequency at which such checks must be performed and a fine amount for not complying with the maintenance check schedule. The safety maintenance screen 2600 may also be provided to a maintenance client for use in documenting performance of maintenance or the like.

The safety rules may define certain information regarding an asset be provided by an asset provider, a non-compliance fine for one or more of the items required. In addition, a safety rule may include requiring enforcement of helmet use to operate an asset.

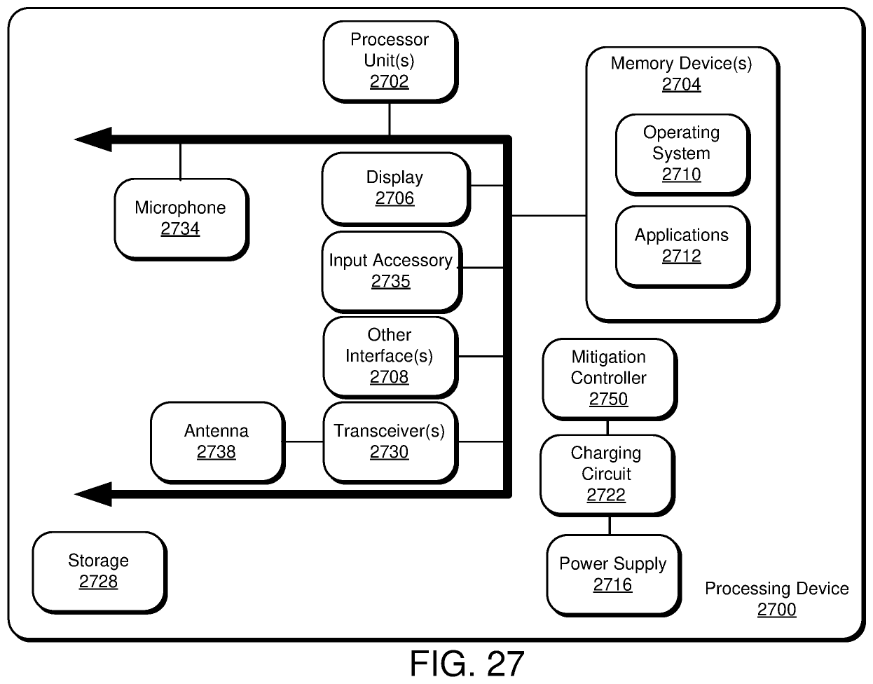

FIG. 27 illustrates an example schematic of a processing device 2700 suitable for implementing aspects of the disclosed technology including the centralized asset management system. The processing device 2700 includes one or more processor unit(s) 2702, memory 2704, a display 2706, and other interfaces 2708 (e.g., buttons). The memory 2704 generally includes both volatile memory (e.g., RAM) and non-volatile memory (e.g., flash memory). An operating system 2710, such as the Apple Macintosh or Microsoft Windows® operating systems, the Apple iPhone or Microsoft Windows® Phone operating systems or a specific operating system designed for a gaming device, resides in the memory 2704 and is executed by the processor unit(s) 2702, although it should be understood that other operating systems may be employed.

One or more applications 2712 are loaded in the memory 2704 and executed on the operating system 2710 by the processor unit(s) 2702. Applications 2712 may receive input from various input local devices such as a microphone 2734, input accessory 2735 (e.g., keypad, mouse, stylus, touchpad, gamepad, racing wheel, joystick). Additionally, the applications 2712 may receive input from one or more remote devices such as remotely-located smart devices (e.g., smart devices 102 and 104 in FIG. 1) by communicating with such devices over a wired or wireless network using more communication transceivers 2730 and an antenna 2738 to provide network connectivity (e.g., a mobile phone network, Wi-Fi®, Bluetooth®). The processing device 2700 may also include various other components, such as a positioning system (e.g., a global positioning satellite transceiver), one or more accelerometers, one or more cameras, an audio interface (e.g., the microphone 2734, an audio amplifier and speaker and/or audio jack), and storage devices 2728. Other configurations may also be employed.

The processing device 2700 further includes a power supply 2716, which is powered by one or more batteries or other power sources and which provides power to other components of the processing device 2700. The power supply 2716 may also be connected to an external power source (not shown) that overrides or recharges the built-in batteries or other power sources.

In an example implementation, an asset management system may include hardware and/or software embodied by instructions stored in the memory 2704 and/or the storage devices 2728 and processed by the processor unit(s) 2702. The memory 2704 may be the memory of a host device or of an accessory that couples to the host.

The processing system 2700 may include a variety of tangible processor-readable storage media and intangible processor-readable communication signals. Tangible processor-readable storage can be embodied by any available media that can be accessed by the processing system 2700 and includes both volatile and nonvolatile storage media, removable and non-removable storage media. Tangible processor-readable storage media excludes intangible communications signals and includes volatile and nonvolatile, removable and non-removable storage media implemented in any method or technology for storage of information such as processor-readable instructions, data structures, program modules or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information and which can be accessed by the processing system 2700. In contrast to tangible processor-readable storage media, intangible processor-readable communication signals may embody processor-readable instructions, data structures, program modules or other data resident in a modulated data signal, such as a carrier wave or other signal transport mechanism. The term “modulated data signal” means an intangible communications signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Some implementations may comprise an article of manufacture. An article of manufacture may comprise a tangible storage medium to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

An example of the present disclosure includes a method for an asset management system for enforcement of one or more asset parameters for assets of a plurality of asset providers that use public infrastructure. The method includes receiving, at the asset management system, asset data regarding the assets of a plurality of asset operators. The method also includes comparing the asset data to one or more asset parameter using a hardware processor of the asset management system and determining, by the hardware processor of the asset management system, that an asset is in non-compliance with the one or more asset parameters. The method also includes communicating a message from the asset management system in response to determining the non-compliance of the asset.

In an example, the one or more assets comprise one of dockless mobility vehicles (DMVs) or autonomous vehicles.

In an example, the receiving operation also includes establishing a network connection between the hardware processor of the asset management system and a network interface of an asset operator. In turn, the method may include receiving the asset data directly from the interface of the asset operator. The asset data may include geolocation information regarding each asset. For example, the geolocation information may be generated by a positioning device onboard each respective one of the plurality of assets.

In an example, the one or more asset parameters may include geolocation parameters defined relative to the public infrastructure. The geolocation parameters may include definitions regarding areas of the public infrastructure for parking the assets when not in use. Additionally or alternatively, the geolocation parameters may include definitions regarding areas of the public infrastructure for operation of the assets. In an example, the determining operation includes determining that the geolocation information regarding the asset is in non-compliance of the geolocation parameters.

In an example, the receiving operation also includes receiving the asset data in a communication from a mobile enforcement device that identifies an asset in non-compliance with the one or more asset parameter. The mobile enforcement device may include a mobile enforcement client including an enforcement interface for use by a user of the mobile enforcement device to provide the asset data. The mobile enforcement client may collect identifying data from the asset for use in generating the communication.

In an example, the one or more asset parameters relate to a collective number of assets without regard to the asset operator of the collective number of assets.

In an example, providing a parameter definition interface accessible by a user to define the one or more asset parameter. The one or more asset parameters may include a geolocation parameter. In turn, the method may include receiving, from the parameter definition interface, one or more geolocation definition of the public infrastructure related to the geolocation parameter. In another example, the one or more asset parameter may include a temporal parameter, and the method may include receiving, from the parameter definition interface, one or more time periods related to the temporal parameter.

In an example, the communicating includes sending the message to an entity that manages the public infrastructure. In another example, the communicating comprises sending the message to an asset operator of the asset determined to be in non-compliance with the one or more asset parameter.

In an example, the method includes providing an externally accessible interface to at least provide real time information regarding the one or more asset parameters.

In an example, the message from the asset management system comprises one of a notice of non-compliance with a grace period to rectify the non-compliance or an instant citation with financial penalty. If the non-compliance is rectified within the grace period, no citation with financial penalty is issued.

Another example of the present disclosure includes an asset management system for assets that use public infrastructure. The system includes one or more network interfaces for receiving asset data regarding assets of a plurality of asset operators, a datastore including a plurality of asset parameters, and a compliance engine operative to compare the asset data to the asset parameters to determine if an asset is compliant with the asset parameters. The system also includes a messaging interface to communicate a message in response to determining non-compliance of an asset. In another example, the present disclosure includes a method of validating data of one or more asset operators. The method includes accessing field data regarding one or more assets of the one or more asset operators that are deployed in public infrastructure and accessing represented data regarding the one or more assets of the one or more asset operators that are deployed in public infrastructure provided by the one or more asset operators. The method also includes comparing the field data and the represented data. In turn, the method includes communicating a message regarding a difference between the field data and the represented data.

In an example, the method also includes receiving the field data from a monitoring device that physically observes the one or more assets. The monitoring device may include a machine vision system to identify an asset and an asset operator of the asset and measures an observed geolocation of the asset.

In an example, the field data may include a timestamp corresponding to the observed geolocation. The observed geolocation may include an array of geolocations over a plurality of corresponding timestamps.

In an example, the comparing operation includes cross checking the observed geolocation of the asset to reported geolocations of assets received from the asset operator in the represented data to determine if the asset is included in the represented data.

In an example, the message may include a citation including a fine amount. The message may be sent to an asset operator for which the difference is determined between the field data regarding an asset of the asset operator and the represented data provided by the asset operator.

In an example, the represented data is received directly from asset operators. The field data may be received from an enforcement client executed by a user device.

Another example of the present disclosure includes a centralized asset management system with validation of represented data of one or more asset providers. The system includes a datastore comprising field data regarding one or more assets of one or more asset operators that are deployed in public infrastructure and represented data regarding assets of the one or more asset operators that are deployed in public infrastructure. The system also includes a data integrity module executed by a hardware processor of the centralized asset management system configured to access the field data and the represented data to compare the field data and the represented data to determine whether a difference between the field data and the represented data exists. A messaging module is operative to generate a message for an asset operator in response to a determined difference between the field data and the represented data for the asset provider.

In an example, the data integrity module receives the field data from a monitoring device that physically observes the one or more assets. The monitoring device may use a machine vision system to identify an asset and an asset operator of the asset and measures an observed geolocation of the asset. The field data may also include a timestamp corresponding to the observed geolocation. In an example, the observed geolocation comprises an array of geolocations over a plurality of corresponding timestamps.

In an example, the data integrity module compares the observed geolocation of the asset to reported geolocations of assets received from the asset operator in the represented data to determine if the asset is included in the represented data.

In an example, the message includes a citation including a fine amount. The messaging module may be in operative communication with an asset operator for which the difference is determined between the field data regarding an asset of the asset operator and the represented data provided by the asset operator.

In an example, the system also includes an asset provider interface for receiving the represented data from the one or more asset providers. The system may also include an enforcement interface for receiving the field data from an enforcement client executed by a user device.

In another example of the present disclosure, one or more tangible processor-readable storage media embodied with instructions for executing on one or more processors and circuits of a device a process of validating data of one or more asset operators is provided. The one or more tangible processor-readable storage media includes instructions for accessing field data regarding one or more assets of the one or more asset operators that are deployed in public infrastructure and accessing represented data regarding the one or more assets of the one or more asset operators that are deployed in public infrastructure provided by the one or more asset operators. The one or more tangible processor-readable storage media include instructions for comparing the field data and the represented data and communicating a message regarding a difference between the field data and the represented data.

In an example, the process further includes receiving the field data from a monitoring device that physically observes the one or more assets. The monitoring device may use a machine vision system to identify an asset and an asset operator of the asset and measures an observed geolocation of the asset.

In an example, the field data further comprises a timestamp corresponding to the observed geolocation. The observed geolocation may include an array of geolocations over a plurality of corresponding timestamps.

In an example, the comparing operation may include cross checking the observed geolocation of the asset to reported geolocations of assets received from the asset operator in the represented data to determine if the asset is included in the represented data.

In an example, the message includes a citation including a fine amount. The message may be sent to an asset operator for which the difference is determined between the field data regarding an asset of the asset operator and the represented data provided by the asset operator.

In an example, the represented data is received directly from asset operators.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

1. A method for an asset management system for enforcement of one or more asset parameters for assets of a plurality of asset providers that use public infrastructure, the method comprising:
receiving, at the asset management system, asset data regarding the assets of a plurality of asset operators, wherein the one or more assets comprise dockless mobility vehicles (DMVs);
comparing the asset data to one or more asset parameter using a hardware processor of the asset management system, the one or more asset parameters relating to a collective number of assets without regard to a number of assets of any particular one of the plurality of asset operators of the collective number of assets;
determining, by the hardware processor of the asset management system, that an asset is in non-compliance with the one or more asset parameters; and
communicating a message from the asset management system in response to determining the non-compliance of the asset.

2. (canceled)

3. The method of claim 1, wherein the receiving operation further comprises:
establishing a network connection between the hardware processor of the asset management system and a network interface of each of the plurality of asset operator;s and
receiving the asset data directly from the interface of each of the plurality of asset operators.

4. The method of claim 3, wherein the asset data comprises geolocation information regarding each asset.

5. The method of claim 4, wherein the geolocation information is generated by a positioning device onboard each respective one of the plurality of assets.

6. The method of claim 5, wherein the one or more asset parameters include geolocation parameters defined relative to the public infrastructure.

7. The method of claim 6, wherein the geolocation parameters comprise definitions regarding areas of the public infrastructure for parking the assets when not in use.

8. The method of claim 6, wherein the geolocation parameters comprise definitions regarding areas of the public infrastructure for operation of the assets.

9. The method of claim 6, wherein the determining operation includes determining that the geolocation information regarding the asset is in non-compliance of the geolocation parameters.

10. The method of claim 1, wherein the receiving operation further comprises:
receiving the asset data in a communication from a mobile enforcement device that identifies an asset in non-compliance with the one or more asset parameter.

11. The method of claim 10, wherein the mobile enforcement device comprises a mobile enforcement client including an enforcement interface for use by a user of the mobile enforcement device to provide the asset data.

12. The method of claim 11, wherein the mobile enforcement client collects identifying data from the asset for use in generating the communication.

13. (canceled)

14. The method of claim 1, further comprising:
providing a parameter definition interface accessible by a user to define the one or more asset parameter.

15. The method of claim 14, wherein the one or more asset parameters comprise a geolocation parameter, and the method further comprises:
receiving, from the parameter definition interface, one or more geolocation definition of the public infrastructure related to the geolocation parameter.

16. The method of claim 14, wherein the one or more asset parameter comprises a temporal parameter, and the method comprises:
receiving, from the parameter definition interface, one or more time periods related to the temporal parameter.

17. The method of claim 1, wherein the communicating comprises sending the message to an entity that manages the public infrastructure.

18. The method of claim 1, wherein the communicating comprises sending the message to an asset operator of the asset determined to be in non-compliance with the one or more asset parameter.

19. The method of claim 1, further comprising:
providing an externally accessible interface to at least provide real time information regarding the one or more asset parameters.

20. The method of claim 1, wherein the message from the asset management system comprises one of a notice of non-compliance with a grace period to rectify the non-compliance or an instant citation with financial penalty.

21. The method of claim 20, wherein if the non-compliance is rectified within the grace period, no citation with financial penalty is issued.

22. An asset management system for assets that use public infrastructure, comprising:
one or more network interfaces for receiving asset data regarding assets of a plurality of asset operators;
a datastore including a plurality of asset parameters;
a compliance engine operative to compare the asset data to the asset parameters to determine if an asset is compliant with the asset parameters; and
a messaging interface to communicate a message in response to determining non-compliance of an asset.

23.-48. (canceled)

49. The method of claim 1, wherein the asset parameter comprises a maximum collective number of assets regardless of a number of assets of any particular one of the plurality of asset operators.

50. The method of claim 49, wherein the maximum collective number of assets relates to parked assets in a given location.

51. The method of claim 49, wherein the maximum collective number of assets relates to assets operating in a given location.

52. The method of claim 1, wherein the asset parameter comprises a minimum number of assets located in a designated location.
